(19) United States
(12) Patent Application Publication
(10) Pub. No.: US 2026/0172957 A1
(43) Pub. Date: Jun. 18, 2026

(54) TECHNIQUES FOR VIRTUAL CELL CONFIGURATION AND INDICATION

(71) Applicant: QUALCOMM Incorporated, San Diego, CA (US)

(72) Inventors: Aria HASANZADEZONUZY, Chatham, NJ (US); Kianoush HOSSEINI, San Diego, CA (US); Gokul SRIDHARAN, Sunnyvale, CA (US); Yongle WU, San Diego, CA (US)

(21) Appl. No.: 18/981,426

(22) Filed: Dec. 13, 2024

(51) Int. Cl. H04W 48/20; H04W 8/22; H04W 48/12

(52) U.S. Cl. CPC H04W 48/20; H04W 8/22; H04W 48/12

(57) ABSTRACT

Methods, systems, and devices for wireless communications are described. Specifically, techniques for configuring, indicating, and attaching to virtual cells (vCells) are described. A user equipment (UE) may receive control signaling that indicates a vCell including a set of serving cells that are grouped together to facilitate wireless communication (e.g., network-selected vCell). Additionally, or alternatively, the control signaling may indicate a set of candidate serving cells that may be grouped together to form a vCell (e.g., UE-selected vCell). The UE may then monitor for additional control signaling from the vCell, where the additional control signaling indicates a set of physical cell identifiers (PCIDs) associated with the set of serving cells of the vCell, a set of frequency resources associated with set of serving cells of the vCell, or both. The UE may then perform a cell selection procedure to access and communicate with the set of serving cells of the vCell.

### FIELD OF TECHNOLOGY

The following relates to wireless communications, including techniques for virtual cell (vCell) configuration and indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving control signaling that indicates a virtual cell (vCell) including a set of serving cells that are grouped together to facilitate wireless communication, a set of multiple candidate serving cells for selecting the set of serving cells of the vCell, or both, monitoring for second control signaling from a first serving cell of the set of serving cells of the vCell based on the control signaling, the second control signaling indicating a set of physical cell identifiers associated with the set of serving cells of the vCell, a set of frequency resources associated with set of serving cells of the vCell, or both, performing a cell selection procedure to access the set of serving cells of the vCell based on the second control signaling, and communicating with the set of serving cells of the vCell in accordance with successful performance of the cell selection procedure.

A UE is described. The UE may include one or more memories storing processor executable code, and one or more processors coupled with the one or more memories. The one or more processors may individually or collectively be operable to execute the code to cause the UE to receive control signaling that indicates a vCell including a set of serving cells that are grouped together to facilitate wireless communication, a set of multiple candidate serving cells for selecting the set of serving cells of the vCell, or both, monitor for second control signaling from a first serving cell of the set of serving cells of the vCell based on the control signaling, the second control signaling indicating a set of physical cell identifiers (PCIDs) associated with the set of serving cells of the vCell, a set of frequency resources associated with set of serving cells of the vCell, or both, perform a cell selection procedure to access the set of serving cells of the vCell based on the second control signaling, and communicate with the set of serving cells of the vCell in accordance with successful performance of the cell selection procedure.

Another UE is described. The UE may include means for receiving control signaling that indicates a vCell including a set of serving cells that are grouped together to facilitate wireless communication, a set of multiple candidate serving cells for selecting the set of serving cells of the vCell, or both, means for monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both, means for performing a cell selection procedure to access the set of serving cells of the vCell based on the second control signaling, and means for communicating with the set of serving cells of the vCell in accordance with successful performance of the cell selection procedure.

A non-transitory computer-readable medium storing code is described. The code may include instructions executable by one or more processors to receive control signaling that indicates a vCell including a set of serving cells that are grouped together to facilitate wireless communication, a set of multiple candidate serving cells for selecting the set of serving cells of the vCell, or both, monitor for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both, perform a cell selection procedure to access the set of serving cells of the vCell based on the second control signaling, and communicate with the set of serving cells of the vCell in accordance with successful performance of the cell selection procedure.

Some examples of the method, UEs, and non-transitory computer-readable medium described herein may further include operations, features, means, or instructions for transmitting, based on the control signaling, a message indicating the set of serving cells from the set of multiple candidate serving cells for formation of the vCell, where monitoring for the second control signaling, performing the cell selection procedure with the vCell, or both, may be based on transmitting the message.

Some examples of the method, UEs, and non-transitory computer-readable medium described herein may further include operations, features, means, or instructions for transmitting, based on the control signaling, a message indicating a subset of serving cells from the set of serving cells for formation of the vCell, where the cell selection procedure may be performed to access the subset of serving cells, and where communicating with the set of serving cells includes communicating with the subset of serving cells.

Some examples of the method, UEs, and non-transitory computer-readable medium described herein may further include operations, features, means, or instructions for receiving, via the control signaling, a set of criteria associated with a selection of the vCell and transmitting a message including an indication of the set of serving cells from the set of multiple candidate serving cells, an indication of a subset of serving cells from the set of serving cells, or both, where a selection of the set of serving cells from the set of multiple candidate serving cells, a selection of the subset of serving cells from the set of serving cells, or both, may be performed in accordance with the set of criteria.

In some examples of the method, UEs, and non-transitory computer-readable medium described herein, the set of criteria include a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.

In some examples of the method, UEs, and non-transitory computer-readable medium described herein, the set of criteria include a criteria that at least one serving cell from the set of serving cells includes a mandatory serving cell for the vCell.

Some examples of the method, UEs, and non-transitory computer-readable medium described herein may further include operations, features, means, or instructions for transmitting capability signaling indicating a capability of the UE to communicate via one or more vCells, where receiving the control signaling, monitoring for the second control signaling, or both, may be based on transmitting the capability signaling.

In some examples of the method, UEs, and non-transitory computer-readable medium described herein, the second control signaling includes a cell-defining synchronization signal block associated with the vCell, a discovery reference signal associated with the vCell, a system information block associated with the vCell, or any combination thereof.

In some examples of the method, UEs, and non-transitory computer-readable medium described herein, the second control signaling includes a set of absolute radio frequency channel numbers (ARFCNs) associated with the set of serving cells of the vCell.

Some examples of the method, UEs, and non-transitory computer-readable medium described herein may further include operations, features, means, or instructions for monitoring for the additional control signaling from the second serving cell of the vCell based on the next information field of the second control signaling, where performing the cell selection procedure, communicating with the set of serving cells of the vCell, or both, may be based on the additional control signaling.

In some examples of the method, UEs, and non-transitory computer-readable medium described herein, a previous information field of the second control signaling indicates that the second control signaling includes an initial control signaling associated with the vCell and a previous information field of the additional control signaling indicates the second control signaling.

In some examples of the method, UEs, and non-transitory computer-readable medium described herein, a next information field of the additional control signaling indicates either a subsequent control signaling associated with the vCell, or indicates that the additional control signaling may be a final control signaling associated with the vCell.

In some examples of the method, UEs, and non-transitory computer-readable medium described herein, the set of PCIDs associated with the set of serving cells include one or more common bits based on the set of serving cells being associated with the vCell.

Some examples of the method, UEs, and non-transitory computer-readable medium described herein may further include operations, features, means, or instructions for receiving, via the control signaling, the second control signaling, or both, a binary mask associated with the vCell and determining the set of serving cells associated with the vCell based on the set of PCIDs and the binary mask.

A method by a network entity is described. The method may include outputting control signaling that indicates a vCell including a set of serving cells that are grouped together to facilitate wireless communication, a set of multiple candidate serving cells for selecting the set of serving cells of the vCell, or both, outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both, performing a cell selection procedure with a UE to enable the UE to access the set of serving cells of the vCell based on the second control signaling, and communicating with the UE via the set of serving cells of the vCell in accordance with successful performance of the cell selection procedure.

A network entity is described. The network entity may include one or more memories storing processor executable code, and one or more processors coupled with the one or more memories. The one or more processors may individually or collectively be operable to execute the code to cause the network entity to output control signaling that indicates a vCell including a set of serving cells that are grouped together to facilitate wireless communication, a set of multiple candidate serving cells for selecting the set of serving cells of the vCell, or both, output second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both, perform a cell selection procedure with a UE to enable the UE to access the set of serving cells of the vCell based on the second control signaling, and communicate with the UE via the set of serving cells of the vCell in accordance with successful performance of the cell selection procedure.

Another network entity is described. The network entity may include means for outputting control signaling that indicates a vCell including a set of serving cells that are grouped together to facilitate wireless communication, a set of multiple candidate serving cells for selecting the set of serving cells of the vCell, or both, means for outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both, means for performing a cell selection procedure with a UE to enable the UE to access the set of serving cells of the vCell based on the second control signaling, and means for communicating with the UE via the set of serving cells of the vCell in accordance with successful performance of the cell selection procedure.

A non-transitory computer-readable medium storing code is described. The code may include instructions executable by one or more processors to output control signaling that indicates a vCell including a set of serving cells that are grouped together to facilitate wireless communication, a set of multiple candidate serving cells for selecting the set of serving cells of the vCell, or both, output second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both, perform a cell selection procedure with a UE to enable the UE to access the set of serving cells of the vCell based on the second control signaling, and communicate with the UE via the set of serving cells of the vCell in accordance with successful performance of the cell selection procedure.

Some examples of the method, network entities, and non-transitory computer-readable medium described herein may further include operations, features, means, or instructions for obtaining, based on the control signaling, a message indicating the set of serving cells from the set of multiple candidate serving cells for formation of the vCell, where outputting the second control signaling, performing the cell selection procedure with the UE, or both, may be based on obtaining the message.

Some examples of the method, network entities, and non-transitory computer-readable medium described herein may further include operations, features, means, or instructions for obtaining, based on the control signaling, a message indicating a subset of serving cells from the set of serving cells for formation of the vCell, where the cell selection procedure may be performed to enable the UE to access the subset of serving cells, and where communicating with the UE via the set of serving cells includes communicating via the subset of serving cells.

Some examples of the method, network entities, and non-transitory computer-readable medium described herein may further include operations, features, means, or instructions for outputting, via the control signaling, a set of criteria associated with a selection of the vCell and obtaining a message including an indication of the set of serving cells from the set of multiple candidate serving cells, an indication of a subset of serving cells from the set of serving cells, or both, where a selection of the set of serving cells from the set of multiple candidate serving cells, a selection of the subset of serving cells from the set of serving cells, or both, may be performed in accordance with the set of criteria.

In some examples of the method, network entities, and non-transitory computer-readable medium described herein, the set of criteria include a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.

In some examples of the method, network entities, and non-transitory computer-readable medium described herein, the set of criteria include a criteria that at least one serving cell from the set of serving cells includes a mandatory serving cell for the vCell.

Some examples of the method, network entities, and non-transitory computer-readable medium described herein may further include operations, features, means, or instructions for obtaining capability signaling indicating a capability of the UE to communicate via one or more vCells, where outputting the control signaling, outputting for the second control signaling, or both, may be based on obtaining the capability signaling.

In some examples of the method, network entities, and non-transitory computer-readable medium described herein, the second control signaling includes a cell-defining synchronization signal block associated with the vCell, a discovery reference signal associated with the vCell, a system information block associated with the vCell, or any combination thereof.

In some examples of the method, network entities, and non-transitory computer-readable medium described herein, the second control signaling includes a set of ARFCNs associated with the set of serving cells of the vCell.

Some examples of the method, network entities, and non-transitory computer-readable medium described herein may further include operations, features, means, or instructions for outputting the additional control signaling via the second serving cell of the vCell based on the next information field of the second control signaling, where performing the cell selection procedure, communicating with the UE via the set of serving cells of the vCell, or both, may be based on the additional control signaling.

In some examples of the method, network entities, and non-transitory computer-readable medium described herein, a previous information field of the second control signaling indicates that the second control signaling includes an initial control signaling associated with the vCell and a previous information field of the additional control signaling indicates the second control signaling.

In some examples of the method, network entities, and non-transitory computer-readable medium described herein, a next information field of the additional control signaling indicates either a subsequent control signaling associated with the vCell, or indicates that the additional control signaling may be a final control signaling associated with the vCell.

In some examples of the method, network entities, and non-transitory computer-readable medium described herein, the set of PCIDs associated with the set of serving cells include one or more common bits based on the set of serving cells being associated with the vCell.

Some examples of the method, network entities, and non-transitory computer-readable medium described herein may further include operations, features, means, or instructions for outputting, via the control signaling, the second control signaling, or both, a binary mask associated with the vCell, where the set of serving cells associated with the vCell may be determined based on the set of PCIDs and the binary mask.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for virtual cell (vCell) configuration and indication in accordance with one or more aspects of the present disclosure.

FIG. 2 shows an example of a wireless communications system that supports techniques for vCell configuration and indication in accordance with one or more aspects of the present disclosure.

FIG. 3 shows an example of a process flow that supports techniques for vCell configuration and indication in accordance with one or more aspects of the present disclosure.

FIGS. 4 and 5 show block diagrams of devices that support techniques for vCell configuration and indication in accordance with one or more aspects of the present disclosure.

FIG. 6 shows a block diagram of a communications manager that supports techniques for vCell configuration and indication in accordance with one or more aspects of the present disclosure.

FIG. 7 shows a diagram of a system including a device that supports techniques for vCell configuration and indication in accordance with one or more aspects of the present disclosure.

FIGS. 8 and 9 show block diagrams of devices that support techniques for vCell configuration and indication in accordance with one or more aspects of the present disclosure.

FIG. 10 shows a block diagram of a communications manager that supports techniques for vCell configuration and indication in accordance with one or more aspects of the present disclosure.

FIG. 11 shows a diagram of a system including a device that supports techniques for vCell configuration and indication in accordance with one or more aspects of the present disclosure.

FIGS. 12 and 13 show flowcharts illustrating methods that support techniques for vCell configuration and indication in accordance with one or more aspects of the present disclosure.

### DETAILED DESCRIPTION

In order to facilitate wireless communications within a wireless communications system, a user equipment (UE) may connect with a serving cell supported by one or more network entities (e.g., base stations). Some wireless networks, such as Fifth Generation (5G) networks, support carrier aggregation or multi-cell operation in which the UE first attaches to and communicates with a primary cell (PCell) (e.g., first component carrier (CC)), then may subsequently connect to other secondary cells (SCells) (e.g., additional CCs). That is, in some wireless networks, separate serving cells operate separately from one another, and may be accessed using separate random access channel (RACH) procedures or other attachment procedures to communicate with the respective cells. Further, in such wireless networks, the parameters for communicating with the PCell and the SCell may be separately configured or established. Such carrier aggregation/multi-cell configurations enable the UE to communicate via multiple cells, which may increase overall throughput and reliability of wireless communications. However, the UE may have relatively little control over which cells/CCs are configured at the UE. Further, performing multiple RACH procedures to attach to multiple cells/CCs may increase the latency with which the UE is able to connect and communicate with the respective cells.

Comparatively, some other wireless networks, such as Sixth Generation (6G) networks, may operate according to service-based access techniques, where resources are allocated based on different application/service needs for the UE. For example, in the context of a 6G network, a UE may attach, connect, or “subscribe” to a set of cells for different applications or services, such as authentication services, gaming services, and the like. In order to support such service-based access, such wireless networks may implement the concept of a “virtual cell” (vCell), which may include (e.g., be composed of) multiple serving cells, multiple sub-bands, multiple CCs, multiple portions of a sub-band, and the like. In such cases, the respective serving cells of a vCell may be grouped together to facilitate wireless communications for one or more applications/services (e.g., an “authentication” vCell that includes multiple serving cells that are grouped together to facilitate wireless communications for authentication services). By connecting with a vCell, the UE may communicate with multiple serving cells, thereby increasing bandwidth and reducing latency, among other advantages. As compared to previous carrier aggregation/multi-cell operation, in which the UE is required to perform separate RACH procedures to attach to PCells and SCells, the UE may be able to perform a single RACH procedure with the vCell to connect to and communicate with all the respective serving cells of the vCell.

For the purposes of the present disclosure, and in the context of a “vCell,” the terms “cell,” “serving cell,” “CC,” “sub-band,” and like terms, may be used interchangeably to refer to subsets of time/frequency resources of a vCell that may be aggregated, combined, bundled, or otherwise grouped together to form the vCell and to facilitate wireless communications via the vCell.

As will be described in further detail herein, the respective serving cells of a vCell may be supported by one or more network entities. That is, the respective serving cells of a vCell may be co-located (e.g., supported by a single network entity), or non-co-located (e.g., supported by multiple, separate network entities). In some aspects, communications parameters for accessing/communicating with a given serving cell 205 individually may be the same or different compared to communications parameters for accessing/communicating with the same serving cell 205 as part of a vCell 210.

In previous wireless networks (e.g., 5G networks), a UE may identify candidate serving cells that are available for cell attachment (e.g., cell selection or re-selection) by monitoring resources for cell-defining synchronization signal blocks (CD-SSBs) associated with the candidate serving cells. In some cases, the UE may communicate with a primary cell (PCell), where the PCell may broadcast information associated with other candidate serving cells, including resources where CD-SSBs for the candidate serving cells are communicated. The UE may perform measurements on the SSBs from various candidate cells, and may select which cell to attach to (e.g., select which cell to “camp on”) based on the measurements. In particular, the UE may evaluate respective serving cells on an individualized basis (e.g., cell-by-cell basis) to determine whether or not to attach to a respective cell and/or perform a handover procedure to a new cell.

However, such mechanisms for identifying and selecting serving cells may not adequately support techniques for configuring, identifying, and selecting vCells. In particular, vCells may include multiple serving cells (e.g., multiple sub-bands, multiple CCs, etc.) that are aggregated, bundled, or otherwise grouped for wireless communications. Some (or all) of the serving cells of the vCell may transmit reference signals (e.g., CD-SSBs) for measurement by UEs, and may or may not transmit system information block (SIB) information. Stated differently, the information regarding the structure of the vCell, such as the location of requisite SSBs and other system information, may be distributed across signaling transmitted by multiple serving cells of the vCell (as opposed to being communicated via a single serving cell, as is the case with “independent” cell operation in 5G networks). As such, previous techniques for broadcasting SSBs and other system information (SI) for cell attachment may not adequately support the concept of a vCell. For example, some wireless communications systems do not have any mechanisms that define how a vCell can be configured or established, much less signaling for indicating such vCell configurations to UEs.

Accordingly, aspects of the present disclosure are directed to signaling, configurations, and other mechanisms for configuring and indicating vCells in a wireless network. In particular, aspects of the present disclosure are directed to mechanisms for forming/configuring vCells, and signaling that that is used to convey the existence and configuration of formed vCells for cell selection and re-selection. For example, in some cases, the network may form a vCell by aggregating, bundling, grouping, or otherwise selecting a set of serving cells that form the vCell, and may signal the existence of the vCell (along with IDs of the respective serving cells of the vCell) to the UE (e.g., network-formed vCells). In other cases, the network may indicate a set of candidate serving cells that may be used to form a vCell, where the UE may select/group a set of vCells from the set of candidate serving cells to form a vCell, and may indicate the selected vCell to the network (e.g., UE-selected vCells).

In the context of UE-selected vCells, the network may indicate criteria (e.g., conditions, restrictions) that the UE may use to select/form the vCell. For example, the set of criteria may indicate one or more “mandatory” serving cells that must be selected for a vCell, or may indicate that the selected vCell must include both uplink and downlink serving cells. For instance, the set of criteria may indicate subsets of serving cells that must be selected in order for the formed vCell to be able to complete a random access channel (RACH) procedure.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for vCell configuration and indication.

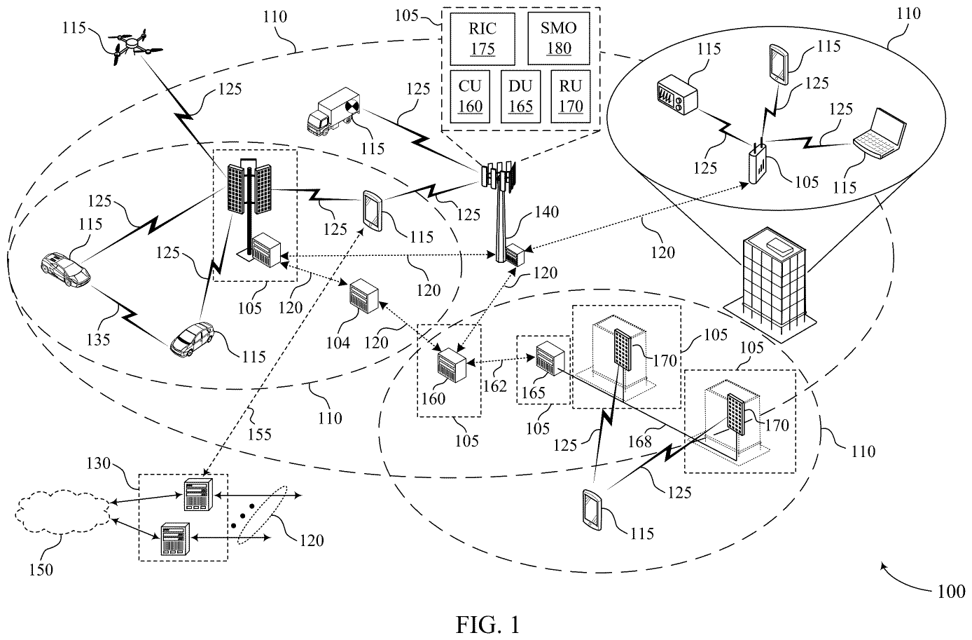

FIG. 1 shows an example of a wireless communications system 100 that supports techniques for vCell configuration and indication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for vCell configuration and indication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10,15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the network entities 105 or the UEs 115 may be

expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a vCell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support signaling, configurations, and other mechanisms for configuring and indicating vCells within the wireless network. In particular, the wireless communications system 100 may support mechanisms for forming/configuring vCells, and signaling that that is used to convey the existence and configuration of formed vCells for cell selection and re-selection. For example, in some cases, a network entity 105 of the wireless communications system 100 may form a vCell by aggregating, bundling, grouping, or otherwise selecting a set of serving cells that form the vCell, and may signal the existence of the vCell (along with IDs of the respective serving cells of the vCell) to a UE 115 (e.g., network-formed vCells). In other cases, the network entity 105 may indicate a set of candidate serving cells that may be used to form a vCell, where the UE 115 may select/group a set of vCells from the set of candidate serving cells to form a vCell, and may indicate the selected vCell to the network (e.g., UE-selected vCells).

In the context of UE-selected vCells, the network entity 105 may indicate criteria (e.g., conditions, restrictions) that the UE 115 may use to select/form the vCell. For example, the set of criteria may indicate one or more “mandatory” serving cells that must be selected for a vCell, or may indicate that the selected vCell must include both uplink and downlink serving cells. For instance, the set of criteria may indicate subsets of serving cells that must be selected in order for the formed vCell to be able to complete a random access channel (RACH) procedure.

Techniques described herein may enable wireless devices (e.g., network entities 105, UEs 115, etc.) to efficiently form, configure, or otherwise create vCells within a wireless network. Further, techniques described herein may enable the network to communicate the existence and structure of formed vCells to enable UEs to attach and communicate with the vCells. By enabling providing mechanisms to create and indicate the existence/structure of vCells to UEs 115, aspects of the present disclosure may enable UEs 115 to attach and communicate with vCells that include with multiple serving cells, thereby increasing bandwidth and reducing latency, among other advantages.

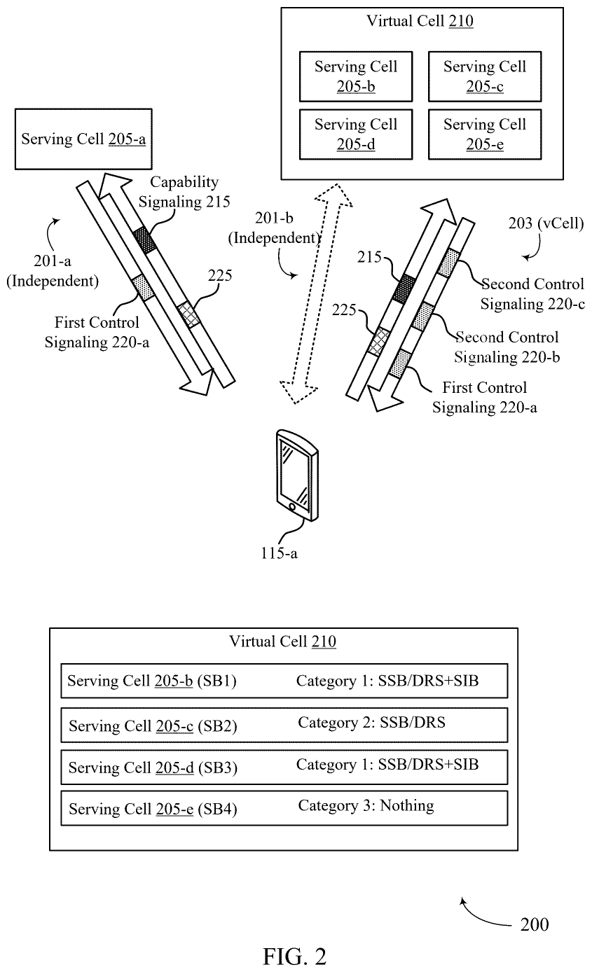

FIG. 2 shows an example of a wireless communications system 200 that supports techniques for vCell configuration and indication in accordance with one or more aspects of the present disclosure. The wireless communications system 200 may implement, or be implemented by, aspects of the wireless communications system 100. For example, the wireless communications system 200 may include a UE 115-a, which may be an example of a UE 115, as described herein with reference to FIG. 1.

In order to perform wireless communications, the UE 115-a may communicate with a serving cell 205, such as the serving cell 205-a. A serving cell 205 may provide the primary network coverage and connectivity to the UE 115-a via a main (e.g., primary) communication link 201-a between the UE 115-a and the wireless network (e.g., the 5G NR network). As described herein, a serving cell 205 may be referred to as a sub-band, a CC (e.g., a sub-band or a portion of a sub-band), or a frequency resource. In this regard, the terms “cell,” “serving cell,” “CC,” “sub-band,” and like terms, may be used interchangeably to refer to subsets of time/frequency resources.

In some wireless communications networks, such as 5G networks, the UE 115-a may select the serving cell 205-a (e.g., a PCell) from multiple serving cells 205 according to a reference signal received power (RSRP) of each serving cell 205, among other examples. Based on selecting the serving cell 205-a, the UE 115-a may enter a connected mode (e.g., RRC connected mode). While operating in the connected mode, if the UE 115-a supports carrier aggregation (e.g., either in the uplink or downlink), a network entity 105 may configure one or more SCells in addition to the serving cell 205-a (e.g., PCell) for communication with the UE 115-a. Accordingly, if the UE 115-a is scheduled to communicate data, the network entity 105 may activate and schedule the SCells for communications with the UE 115-a.

As an illustrative example, the UE 115-a may support downlink carrier aggregation, where the UE 115-a may receive data from the serving cell 205-a and one or more SCells simultaneously. Similarly, the UE 115-a may support uplink carrier aggregation, where the UE 115-a may transmit data to the wireless network via the serving cell 205-a and one or more SCells simultaneously.

In some cases, however, the network entity 105 may configure (e.g., allocate or assign) the one or more SCells blindly. For example, the network entity 105 may configure the SCells independent of the traffic patterns at the UE 115-a, independent of the applications associated with the UE 115-a, or independent of the coverage condition of the UE 115-a (e.g., whether the UE 115-a is located at the cell-edge or cell-center), among other examples.

As such, except for reporting capabilities associated with carrier aggregations, the UE 115-a may not have control of which SCells (e.g., CCs) are configured for carrier aggregation (e.g., in both uplink and downlink), where such configured SCells may not adequately support the applications associated with the UE 115-a and may have a negative impact on the power consumption of the UE 115-a.

In some cases, it may be desirable to configure the downlink and uplink SCells (e.g., frequency resources, CCs) according to the traffic patterns of the applications associated with the UE 115-a. For example, the UE 115-a may be enabled to access one or more SCells (e.g., the carrier aggregation combination) that are based on the service metrics at the UE 115-a, based on the coverage conditions at the UE 115-a, and based on the capabilities of the UE 115-a.

That is, the UE 115-a may be enabled to perform vCell 210 selection and re-selection with downlink and uplink serving cells 205 according to various conditions at the UE 115-a. By doing so, the UE 115-a may experience an improvement in capacity (e.g., bandwidth) for downlink communications, while also experiencing an improvement in capacity as well as coverage for uplink communications. For downlink communications, improving capacity may be a primary target or goal, while for uplink communications, depending on the UE 115 coverage situation in the cell, capacity as well as coverage may considered the main key performance indicators (KPIs).

As described herein, a vCell 210 may include (e.g., be composed of) one or more serving cells 205 (e.g., multiple sub-bands, CCs, frequency resources), where each serving cell 205 of a vCell 210 may be allocated as either an uplink serving cell 205, a downlink serving cell 205, or both an uplink and downlink serving cell 205. As an illustrative example, the vCell 210 may include four serving cells 205, such as the serving cell 205-b, the serving cell 205-c, the serving cell 205-d, and the serving cell 205-e. The respective serving cells 205 of the vCell 210 may be grouped together to facilitate wireless communications for one or more applications/services. For instance, the vCell 210 may support authentication services, where the respective serving cells 205 of the vCell 210 may be combined, bundled, or otherwise grouped together to support various aspects of the authentication services.

As described previously herein, in some wireless networks, such as 5G networks, the UE 115-a may first attach to and communicate with a PCell (e.g., serving cell 205-a), then may subsequently connect to other SCells. That is, in some wireless networks, separate serving cells 205 may operate separately from one another, and must be accessed using separate RACH procedures or other attachment procedures to communicate with the respective cells. Further, in such wireless networks, the parameters for communicating with the individual serving cells 205-a may be separately configured or established.

Comparatively, some other wireless networks, such as 6G networks, may implement the concept of a vCell 210, which may include (e.g., be composed of) multiple serving cells 205, multiple sub-bands, multiple CCs, multiple portions of a sub-band, and the like. In such cases, the respective serving cells 205 of the vCell 210 may be grouped together to facilitate wireless communications for one or more applications/services. As compared to previous carrier aggregation/multi-cell operation, in which the UE 115-a is required to perform separate RACH procedures to attach to PCells and SCells, the UE 115-a may be able to perform a single RACH procedure with the vCell 210 to connect to and communicate with all the respective serving cells 205 of the vCell 210.

In this regard, the serving cell 205-a may be an example of a “standalone” serving cell 205-a that may or may not be a part of a vCell 210, and which is accessible via a communication link 201-a. Comparatively, the vCell 210 may include a group of serving cells 205-b, 205-c, 205-d, 205-e that are aggregated, bundled, or otherwise grouped together to facilitate wireless communications via one or more communication links, such as the communication link 203.

Furthermore, in addition to facilitating communications as part of the vCell 210, the respective serving cells 205 of the vCell 210 may also support or otherwise facilitate wireless communications with the UE 115 that are separate or independent from the vCell 210 (e.g., via a communication link 201-b for “independent” communications). That is, each of the respective serving cells 205 may be accessible individually (e.g., as standalone serving cells 205, such as in 5G), and/or as part of a vCell 210 (e.g., as a group of serving cells 205, such as in 6G). For example, the UE 115-a may communicate with the serving cell 205-d as part of the vCell 210 via the communication link 203, and may additionally and/or alternatively communicate with the same serving cell 205-d separately/independently from the vCell 210 via the communication link 201-b.

In some examples, each of the serving cells 205 of the vCell 210 may be operated by a single network entity 105 (e.g., co-located). In other examples, a first subset of the serving cells 205 of the vCell 210 may be operated by a first network entity 105 and a second subset of the serving cells 205 of the vCell 210 may be operated by a second network entity 105 (e.g., non-co-located).

In such cases, one or more vCells 210 may be formed (e.g., allocated) each having a different combination of serving cells 205. In some examples, the network entity 105 may form the vCell 210, where, to form the vCell 210, the network entity 105 may select the serving cells 205 and indicate the vCell 210 to the UE 115-a. Alternatively, the network entity 105 may indicate “candidate” serving cells 205 which may be bundled/grouped to form a vCell 210, where the UE 115-a may form the vCell 210 by selecting a set of serving cells 205 from the set of candidate serving cells 205. Accordingly, a complete vCell 210, one either formed by the UE 115-a or the network entity 105, may include serving cells 205 that enable the UE 115-a to access the vCell 210 (e.g., include uplink and downlink serving cells 205). As such, if each step of a RACH procedure could be performed using the serving cells 205 of a vCell 210, then the vCell 210 is complete.

As part of UE-initiated access (e.g., in uplink), the UE 115-a may be aware of the current service metrics and coverage conditions, such that the UE 115-a may select one of the formed vCells 210 accordingly (e.g., select a carrier aggregation combination). Additionally, for downlink, the UE 115-a may utilize a paging procedure to identify and select one of the formed vCells 210.

Accordingly, such service-based access may provide a universal access solution for different tiers of UEs 115. For example, a first tier of UEs 115 may aggregate an increased quantity of serving cells 205 within a vCell 210 (e.g., an increased quantity of bandwidth), while a second tier of UEs 115 may select a single serving cell 205 (e.g., a limited BW) for communications. As such, if a network entity 105 advertises different vCells 210, each including a different quantity of downlink and uplink serving cells 205, each UE 115 can select a vCell 210 according to the service metrics, traffic patterns, coverage conditions, and capabilities, among other examples.

In some aspects, the use of vCells 210 may reduce the latency with which the UE 115-a is able to connect and communicate with the respective serving cells 205 of the vCell 210. That is, the configuration of the SCells in conventional carrier aggregation contexts may increase latency. In particular, in the context of conventional carrier aggregation/multi-cell operation, downlink and uplink SCell configurations may account for a relatively large portion of latency to get the SCells to an operational state. As an illustrative example, the latency associated with downlink SCell configuration latency may account for approximately 43% of the total latency, while the latency for uplink SCell configuration may account for approximately about 83% of the total latency.

For instance, to configure the SCells in conventional downlink carrier aggregation, the UE 115-a may transmit a first RRC message (e.g., RRC Setup Comp) to request the configuration of one or more SCells. In response, the network entity 105 may transmit a second RRC message (e.g., RRC Reconfig) including the carrier aggregation configuration that configures one or more SCells, where the UE 115-a may transmit a third RRC message (e.g., RRC Reconfig Complete) indicating that the UE 115-a has received the carrier aggregation configuration.

In response to receiving the third RRC message, the network entity 105 may transmit a MAC control element (MAC-CE) activating a first SCell of the one or more SCells indicated in the carrier aggregation configuration. Accordingly, the UE 115-a may perform channel measurements on the first SCell and transmit channel state feedback (e.g., channel state information (CSI)) to the network entity 105. If the channel state feedback of the first SCell is sufficient, the network entity 105 may schedule a data (e.g., a physical downlink shared channel (PDSCH) transmission) via the first SCell, such that the UE 115-a may receive the data via the first SCell.

In such cases, however, the UE 115-a may experience an increased configuration delay between the transmission of the first RRC message and the reception of the second RRC message, experience an activation delay between transmission of the third RRC message and reception of the MAC-CE, and experience a scheduling delay between the transmission of the channel state feedback and the reception of the data.

Similarly, to configure the SCells in conventional uplink carrier aggregation, the UE 115-a may transmit a first RRC message (e.g., RRC Setup Comp) to request the configuration of one or more SCells. In response, the network entity 105 may transmit a second RRC message (e.g., RRC Reconfig, event A1) and transmit a third RRC message (e.g., RRC Reconfig) that includes the carrier aggregation configuration that configures one or more SCells.

In response to receiving the carrier aggregation configuration, the UE 115-a may transmit a buffer status report (BSR) indicating a quantity of data to be transmitted from the UE 115-a. Based on receiving the BSR, the network entity 105 may transmit a MAC-CE activating a first SCell of the one or more SCells indicated in the carrier aggregation configuration. The network entity 105 may also transmit resources via which the UE 115-a may transmit the data (e.g., physical uplink shared channel (PUSCH)).

In such cases, however, the UE 115-a may experience an increased configuration delay between the transmission of the first RRC message and the reception of the second and third RRC messages, experience an activation delay between reception of the third RRC message and reception of the MAC-CE, and experience a scheduling delay between reception of MAC-CE and the reception of the resources for the data.

As such, by allowing the UE 115-a to select the vCell 210 (e.g., selecting a combination of serving cells 205), the UE 115-a may experience a reduction to the overall latency. For example, the UE 115-a and the network entity 105 may communicate the measurements and signaling related to SCell configuration in parallel (e.g., via multiple serving cells 205) and as part of cell selection. Accordingly, with access to the vCell 210, the UE 115-a may be ready to communicate (e.g., transmit or receive) via each serving cell 205 within a vCell 210 in response to entering the connected state (e.g., the RRC connected state).

In some cases, the UE 115-a may utilize the vCell 210 during a RACH procedure (e.g., initial access, access procedures) to reduce latency and improve efficiency. For example, the UE 115-a (or the network entity 105) may leverage each serving cell 205 (e.g., each band) of a vCell 210 starting from the RACH procedure, where the UE 115-a may select a vCell 210 that includes serving cells 205 associated with improved uplink communications and include serving cells 205 associated with improved downlink communications.

As an illustrative example, the UE 115-a may transmit uplink messages (e.g., message 1, message 3, or message A) of the RACH procedure using a first set of serving cells 205 of the vCell 210 that are associated with frequency division duplexing (FDD) (e.g., lower frequency bands), while the UE 115-a may receive downlink messages (e.g., message 2, message 4, or message B) of the RACH procedure using a second set of serving cells of the vCell 210 that are associated with time division duplexing (TDD).

In such cases, FDD bands may be more efficient for uplink communications rather than TDD bands due to a smaller subcarrier spacing of FDD bands (e.g., improved coverage areas), due to unrestricted slot formats allowing for lower latency and more efficient repetition handling, and due to increased network energy efficiency while monitoring for the uplink messages (e.g., RACH monitoring in FDD verse TDD), among other examples.

Additionally, in some cases, the FDD bands may be more efficient for uplink communications rather than TDD bands due to the UE 115-a being able to achieve a relatively increased output power in FDD bands relative to TDD bands, which may depend on a transmission chain of the UE 115-a (e.g., 1 power amplifier (PA) associated with 26 dBm gain in FDD vs. two PAs associated with 23 dBm gain each in TDD). Further PAs in relatively higher bands (e.g., TDD bands) may not be efficient. Accordingly, selecting a transmission chain may become increasingly complex for a UE 115 including 4 transmission chains (e.g., 4Tx UEs).

Further, in both uplink and downlink communications, the UE 115-a may benefit from flexibility in selecting the serving cells 205 of the vCell 210, which may reduce complexity of radio frequency management, affect placement of antennas and managing exposure, and affect the total power considerations for uplink communications. For example, because power class is defined as the aggregated power across serving cells 205 (e.g., sub-bands or bands), the UE 115-a may decide which bands to aggregate to be able to more efficiently handle exposures (e.g., maximum permissible exposures (MPEs) or Specific Absorption Rate).

As noted previously herein, in some wireless networks (e.g., 5G networks), the UE 115-a may identify candidate serving cells 205 that are available for cell attachment (e.g., cell selection or re-selection) by monitoring resources for CD-SSBs associated with the candidate serving cells 205. In some cases, the UE 115-a may communicate with a PCell (e.g., serving cell 205-a), where the PCell may broadcast information associated with other candidate serving cells 205, including resources where CD-SSBs for the candidate serving cells 205 are communicated.

The UE 115-a may perform measurements on the SSBs from various candidate cells, and may select which cell to attach to (e.g., select which cell to “camp on”) based on the measurements. In particular, the UE 115-a may evaluate respective serving cells 205 on an individualized basis (e.g., cell-by-cell basis) to determine whether or not to attach to a respective cell and/or perform a handover procedure to a new cell. For example, in some cases, the UE 115-a may perform a cell search by monitoring specific raster points where CD-SSBs may be located. After choosing a suitable cell (e.g., a cell that passes initial cell selection criteria, is not barred, and is for the selected PLMN), the UE 115-a may monitor for control signaling/information on the selected cell in a procedure that may be referred to as “camping on the cell.”

However, such mechanisms for identifying and selecting serving cells may not adequately support techniques for configuring, identifying, and selecting vCells. In particular, vCells 210 may include multiple serving cells (e.g., multiple sub-bands, multiple CCs, etc.) that are aggregated, bundled, or otherwise grouped for wireless communications, such as the serving cells 205-b, 205-c, 205-d, and 205-e. Each of these “building blocks” of the vCell 210 (e.g., serving cells 205) may be both part of the vCell 210 (or part of multiple vCells 210), and/or may operate as independent cells. That is, each of the respective serving cells 205 may be accessible individually (e.g., as standalone serving cells 205, such as in 5G), and/or as part of a vCell 210 (e.g., as a group of serving cells 205, such as in 6G). In the context of a vCell 210, some (or all) of the constituent serving cells 205 may transmit reference signals for measurement, such as CD-SSBs, non-CD-SSBs (NCD-SSBs), discovery reference signals (DRSs), and the like. Similarly, each of the serving cells 205 of the vCell 210 may or may not transmit SIB information.

Stated differently, the information regarding the structure of the vCell 210, such as the location of requisite SSBs and other system information, may be distributed across signaling transmitted by multiple serving cells 205 of the vCell 210 (as opposed to being communicated via a single serving cell 205, as is the case with “independent” cell operation in 5G networks). As such, previous techniques for broadcasting SSBs and other SI for cell attachment may not adequately support the concept of a vCell 210. For example, some wireless communications systems do not have any mechanisms that define how a vCell 210 can be configured or established, much less signaling for indicating such vCell 210 configurations to UEs 115.

Accordingly, aspects of the present disclosure are directed to signaling, configurations, and other mechanisms for configuring and indicating vCells 210 in a wireless network. In particular, aspects of the present disclosure are directed to mechanisms for forming/configuring vCells 210, and signaling that that is used to convey the existence and configuration of formed vCells 210 for cell selection and re-selection. For the purposes of the present disclosure, a vCell 210 may or may not exhibit duplexing symmetry between serving cells 205 (e.g., sub-bands, CCs) that form a vCell 210. For example, the vCell 210 may include three serving cells 205 (e.g., three sub-bands, three CCs), where (1) two of the serving cells 205 (e.g., two of the sub-bands, two of the CCs) are downlink and one is uplink (or vice versa), (2) one serving cell 205 is downlink-only, one is uplink-only, and one is both downlink/uplink, etc.

For example, referring to FIG. 2, the UE 115-a may be allowed to access the vCell 210 as part of cell selection (and/or re-selection) procedure. Wireless network may include different categories and/or types of UEs 115 that are (or are not) able to access vCells 210. That is, access to the vCell 210 may be based on UE capability, which may be indicated to the serving cell 205-a, the vCell 210, or both, via capability signaling 215. The capability signaling 215 may be communicated for vCell 210 re-selection using different capability signaling types (e.g., per-band, or separate capabilities for downlink and uplink via per downlink/uplink FS signaling). In some cases, the capability of the UE 115-a to access vCells 210 may be based on (e.g., dependent on) the number/quantity of serving cells 205 forming the respective vCell 210. Conditions/restrictions on the ability of the UE 115-a to access vCells 210 may be indicated via the capability signaling 215.

In some implementations, vCells may be network-specific (e.g., network-selected vCells 210), and/or may be UE-specific (e.g., UE-selected vCells 210). For example, the UE 115-a may receive first control signaling 220-a from the serving cell 205, the vCell 210, or both, where the first control signaling 220-a may indicate candidate vCells (e.g., vCell 210) that may be accessed by the UE 115-a, and/or may indicate candidate serving cells 205 that may be selected to form/configure a vCell 210.

For instance, in the context of network-selected vCells 210 (e.g., network-specific vCells 210), the first control signaling 220-a may indicate the vCell 210, and may indicate the set of serving cells that make up the vCell 210. In such cases, the network may create, select, or otherwise identify which serving cells 205 are aggregated/grouped to form a given vCell 210, and may indicate the available vCells 210 to the UE 115-a. In some cases, the UE 115-a is not able to choose or select which serving cells 205 are grouped to form/construct a vCell 210. In other cases, the UE 115-a may be able to choose a subset serving cells 205 of a given vCell 210 that UE 115-a is to attach to (but the UE 115-a can not select additional or alternative serving cells 205 that are to be included within a formed vCell 210). For example, the first control signaling 220-a may indicate that the vCell 210 includes serving cells 205-b, 205-c, 205-d, and 205-e. In this example, the UE 115-a may attach to the vCell 210 “as is” (e.g., with serving cells 205-b, 205-c, 205-d, and 205-e), or may select only a subset of the serving cells 205 for cell attachment (effectively forming a different, smaller vCell 210 from serving cells 205-b, 205-c, 205-d, and 205-e).

Stated differently, in the context of a network-selected vCell 210 (e.g., network-specific vCell 210), the network may provide options to the UE 115-a to indicate whether the UE 115-a is able to select a subset of the indicated serving cells 205 for the vCell 210, or whether the UE 115-a is to adhere to the whole vCell 210 indicated. That is, the network may indicate to the UE 115-a whether the UE 115-a is allowed to select a subset of the serving cells 205 indicated as part the vCell 210 advertised by the network or not. Even if the network allows the UE 115-a to choose from serving cells 205 of network-selected vCell 210, some of the serving cells 205 may still be required to be included as part of the vCell 210 (e.g., the UE 115-a can not exclude some indicated serving cells 205 from the vCell 210 it selects, as will be described in further detail herein). In such cases, the network may indicate which serving cells 205 of the vCell 210 are “mandatory,” and which serving cells 205 are “optional” (e.g., via a list or bitmap).

Conversely, in the context of UE-selected vCells 210 (e.g., UE-specific vCells 210), the first control signaling 220-a may indicate candidate serving cells 205 that may be selected/grouped by the UE 115-a to form a vCell 210. That is, the network may provide a “menu” of candidate serving cells 205 that may be selected and used to form a vCell 210, where the UE 115-a is able to choose from the set of candidate serving cells 205 to form a UE-specific vCell 210.

For UE-selected vCells 210 (e.g., UE-specific vCells 210), and/or in cases where the UE 115-a is able to select a subset of serving cells of a network-selected vCell 210, the choice of the serving cells 205 that are bundled/grouped into a vCell 210 may be left to UE implementation. In other cases, the network may impose some restrictions or criteria on the vCell 210 construction may. For example, the first control signaling 220-a may indicate a set of criteria associated with selection of the vCell 210. The criteria may include rules, conditions, or other restrictions that the UE 115-a is to use to select the serving cells 205 for a vCell 210.

For example, one criteria may indicate that each vCell 210 is expected to include both downlink and uplink serving cells 205. Another criteria may indicate that each vCell is expected to include both downlink and uplink serving cells in certain frequency bands (e.g., some of the downlink/uplink serving cells 205 should be in the same frequency band or the same FR, or at least one downlink/uplink serving cell 205 should be in a certain band in FDD or TDD). Another criteria may indicate maximum or minimum quantities/numbers of serving cells 205 forming a vCell 210 (either absolute quantities/numbers, or the relation of the number of downlink to uplink serving cells 205, such as a 1:1 ratio, etc.). Yet another criteria may indicate a maximum or minimum total bandwidth of a vCell 210 (e.g., jointly or separately for downlink and uplink, jointly or separately per band, etc.). In other cases, the set of criteria may indicate one or more “mandatory” serving cells that must be selected for a vCell 210.

In some implementations, the set of criteria for constructing a vCell 210 may indicate that at least one serving cell 205 of the vCell 210 is expected to transmit CD-SSB or (DRS) carrying PCIDs and/or SIB for the vCell 210, but that not every serving cell 205 of the vCell 210 is expected to transmit such information.

In this regard, for UE-selected vCells 210, the UE 115-a may select a set of serving cells 205 that are to be aggregated, bundled, or otherwise grouped to form the vCell 210. The UE 115-a may select the serving cells 205 for the vCell 210 from the set of candidate serving cells 205 indicated via first control signaling 220-a. Further, the UE 115-a may select the serving cells 205 of the vCell 210 in accordance with the set of criteria indicated via the first control signaling 220-a. The UE 115-a may transmit a message 225 to the serving cell 205-a, the vCell 210 (e.g., one or more cells/CCs of the vCell 210), or both, where the message 225 indicates the set of serving cells 205 selected to form the vCell 210. That is, in the case of a UE-selected vCell 210, the UE 115-a may indicate (via message 225) which serving cells 205 are being aggregated/grouped to form the vCell 210.

After formation/indication of the vCell 210, UE 115-a may monitor for control signaling (e.g., second control signaling 220-b) from the vCell 210. That is, the UE 115-a may monitor for control signaling 220 (e.g., second control signaling 220-b) transmitted by one or more serving cells 205 of the vCell 210. In some aspects, the respective serving cells 205 of the vCell 210 may be configured to transmit different types of signals and/or different information for accessing the vCell 210. That is, each vCell 210 may include one or more types or categories of serving cells 205 that exhibit different characteristics, different capabilities, and/or that support different types of signaling.

For example, the vCell 210 may include one or more serving cells 205 that transmit (1) SSBs/DRSs and SIBs, (2) only SSBs/DRSs, and/or (3) do not transmit anything. For instance, as shown in FIG. 2, the first and third serving cells 205-b, 205-d (e.g., first and third sub-bands) of the vCell 210 may be associated with the first category, the second serving cell 205-c may be associated with the second category, and the fourth serving cell 205-d may be associated with the third category. In this example, the vCell 210 may effectively include three different “categories” of serving cells 205 that transmit different types of signals/information that is used to indicate the structure of the vCell 210, and which is used by the UE 115-a to access the vCell 210. In such cases, the first category of serving cells (e.g., serving cells 205 that transmit SSBs/DRSs+SIBs) should include information about other serving cells 205 of the vCell 210 in order to indicate the structure/configuration of the vCell 210 to the UE 115-a.

For instance, all (or a subset) of the first category of serving cells 205 that transmit SSBs/DRSs+SIBs may transmit/broadcast PCIDs, ARFCNs, and/or center frequencies of SSBs/DRSs for other serving cells 205 of the vCell that transmit SSBs/DRSs. Additionally, or alternatively, all (or a subset) of the first category of serving cells 205 that transmit SSBs/DRSs+SIBs may transmit/broadcast, for other serving cells 205 that do not transmit anything, gaps between frequency ranges of the other serving cells 205 (e.g., start/center/end of the frequency ranges of the other serving cells 205 of the vCell 210), bandwidths of the other serving cells 205 (e.g., start/center/end frequencies of the other serving cells 205), etc.

In some aspects, the network may extend SIB1 (for the category/categories of serving cells 205 of the vCell 210 that transmit SIB1) to include the information about other serving cells 205 of the vCell. That is, SIB1 messages may be extended (e.g., added bit fields) or modified within networks that support vCells 210. Additionally, or alternatively, the network may define a new SIB for vCells 210 (e.g., SIBv) that includes information about other serving cells 205 of a vCell. In such cases, the network (e.g., serving cells 205 of the vCell 210) may transmit the SIBv with a similar periodicity/frequency as SIB1, and/or with a higher periodicity (e.g., more frequently) than other SIBs, such as SIB2.

In this regard, in some cases, the wireless communications system 200 may support different types of SIBs that are dedicated for (1) serving cells 205 that are associated with a vCell 210, and (2) independent (e.g., non-vCell) serving cells 205. As such, because some serving cells 205 may operate independently (e.g., separately from a vCell 210) as well as part of a vCell 210, some serving cells 205 may transmit multiple types of SIBs (e.g., first SIB for independent cell operation, and second SIBv for the vCell 210).

In additional or alternative implementations, the full set of information for communicating with the serving cells 205 of the vCell 210 may only be transmitted/carried by one (or more) of the serving cells 205 of the vCell 210. For example, a subset (e.g., at least one) of the serving cells 205 of the vCell 210 of the first category (e.g., serving cells 205 that transmit SSBs/DRSs+SIBs) may transmit full vCell information for all other serving cells 205 of the vCell, where the remaining serving cells 205 of the first category may include only partial information about the vCell 210. This partial information may include, but is not limited to, information that the respective serving cell 205 is potentially a part of a vCell 210, a pointer to other serving cells 205 of the vCell 210 where full information for the vCell 210 may be acquired, information about the respective serving cell and/or a subset of other serving cell 205 of the vCell 210, and the like. Cases where only a subset of the first category of serving cells 205 transmit full information of the vCell 210 may reduce control signaling overhead, and may reduce the quantity of duplicated information that is transmitted via the respective cells of the vCell 210.

To further reduce control signaling overhead, in some implementations, the network (e.g., vCell 210) may spread the information of other serving cells 205 across the SIBs transmitted by the first category of serving cells 205 (e.g., serving cells 205 transmitting SSBs/DRSs+SIBs). In such cases, the UE 115-a may be expected to acquire the different pieces, subsets, or portions of information from different serving cells 205 of the vCell 210 in order to determine the structure of the vCell 210 and communicate with the vCell 210.

For example, each serving cell 205 of the first category (e.g., serving cells 205 that transmit SSB/DRS+SIB) may transmit SIBs that include the information about a subset of other serving cells 205 that do not transmit SIBs (e.g., serving cells of the second category, previous cells when assuming that cells are indexed). That is, each SIB (e.g., control signaling 220) may indicate the next SIB/serving cell 205 of the vCell 210 that the UE 115-a should monitor to acquire the next portion of information for communicating with the vCell 210.

Stated differently, in order to communicate with the vCell 210, the UE 115-a may be expected to receive multiple control messages/signaling (e.g., different subsets or segments of control information) from various serving cells 205 of the vCell 210. In this regard, the control signaling 220-a may include a “next information field” (e.g., next cell/sub-band field) and/or a “previous information field” (e.g., previous cell/sub-band field) that indicates additional control messages/signaling that is transmitted by the vCell 210. In other words, the second control signaling 220-b may include information that indicates which subset/portion of control information is being communicated via the second control signaling 220-b.

For instance, if the “previous information field” of the second control signaling 220-b is empty (or otherwise set to some predetermined/configured value), the UE 115-a may be able to determine that the second control signaling 220-b includes the initial (e.g., earliest, first) portion/subset of information for accessing the vCell 210. Otherwise, the “previous information field” may indicate resources for receiving the previous subset/portion of information for accessing the vCell 210. Conversely, if the “next information field” of the second control signaling 220-b is empty (or otherwise set to some predetermined/configured value), the UE 115-a may be able to determine that the second control signaling 220-b includes the last portion/subset of information for accessing the vCell 210. Otherwise, the “next information field” may indicate resources for receiving the subsequent subset/portion of information for accessing the vCell 210. In this regard, the “previous information field” and the “next information field” may enable the UE 115-a to determine which subsets/portions of information are still needed in order to access the vCell 210.

By way of another example, as shown in FIG. 2, the serving cells 205-b, 205-d of the vCell 210 may be associated with the first category (e.g., transmit SSB/DRS+SIB). Comparatively, the serving cell 205-c may be associated with the second category (e.g., transmits SSB/DRS, such as transmits CD-SSB without SIB for the vCell 210 or NCD-SSB/DRS/RS), and the serving cell 205-d may be associated with the third category (e.g., not transmitting either SSB/DRS or SIB). In this example, the SIB1 (e.g., second control signaling 220-b) of the serving cell 205-b may leave the “previous information field” blank (indicating the SIB1 is the first/earliest SIB1 for the vCell 210). The SIB1 (e.g., second control signaling 220-b) of the serving cell 205-b and may further include the PCID(s) and/or ARFCN(s) of the serving cell 205-b and/or serving cell 205-d and/or in the “next information field.” In this regard, the UE 115-b may monitor for additional control signaling 220-c from the serving cells 205-c, 205-d based on information within the SIB1 (second control signaling 220-b) received from the serving cell 205-b. Similarly, the SIB1 (e.g., additional control signaling 220-c) of the serving cell 205-d may include PCID and/or ARFCN of the serving cell 205-a in the “previous information field.” Further, the SIB1 (e.g., additional control signaling 220-c) of the serving cell 205-d may indicate start and end frequencies of the serving cell 205-e in an “other information field” (e.g., other cell/sub-band field), and may leave the “next information field” blank (indicating the SIB1/additional control signaling 220-c of the serving cell 205-b is the last subset/portion of information needed to access the vCell 210).

In some implementations, the various control signaling 220 transmitted by the serving cell 205-a and/or the serving cells 205 of the vCell 210 may indicate to the UE 115-a whether the indicated serving cells 205 form a vCell 210 (for network-selected vCells 210), and/or whether the UE 115-a is able to select from the indicated serving cells 205 to create the vCell 210. For example, the SIBs (e.g., control signaling 220) transmitted by the serving cells 205 of the vCell 210 may indicate whether the vCell 210 is network-selected (e.g., network-specific vCell 210) or UE-selected (e.g., UE-specific vCell 210).

As noted previously herein, in some cases, the control signaling 220-a, 220-b, 220-c may indicate the list of serving cells 205 of the vCell 210 via a list or bitmap. Another approach to identify the serving cells 205 of the vCell 210 is to use the PCIDs of the respective serving cells 205 of the vCells 210 in the SSBs/DRSs, and/or SIBs transmitted by the vCell 210. For example, the network may implement a rule that serving cells 205 that are part of the same vCell 210 are associated with PCIDs that have some common characteristics, such as some bits in common.

For example, the serving cells 205-b, 205-c, 205-d, 205-e of the vCell 210 may be associated with PCIDs that have three most significant bits (MSB) in common, thereby indicating that the serving cells 205-b, 205-c, 205-d, 205-e are part of the same vCell 210 (e.g., PCIDs 101001, 101010, 101111, and 101011 are part of the same vCell 210 with a vCell PCID of 101).

Additionally, or alternatively, the network may indicate a binary mask (e.g., binary mask of the size of the serving cell PCIDs) to indicate the vCell 210. In such cases, the UE 115-a may determine that two different serving cells 205 are part of the same vCell 210 if and only if their PCID ×indicated mask are equal (e.g., SBᵢ with PCIDᵢ and SBⱼ with PCIDⱼ are part of the same vCell 210 if and only PCIDᵢ ×mask =PCIDⱼ ×mask). The mask may be indicated via the SIB (e.g., second control signaling 220-b, additional control signaling 220-c) of a serving cell 205 of the vCell 210, via a SIB of another serving cell which is not part of the same vCell 210 (e.g., serving cell 205-a), or in dedicated manner. For instance, two different serving cells 205 with PCIDs 101010 and 101110 may belong to the same vCell 210 with mask 111000.

One special case for using a mask is a case where the mask is all 1s. This implies that the serving cells 205 of the vCell 210 would have the same PCID. However, this special case could potentially cause confusion for the UE 115-a when referring to a serving cell 205, and the UE 115-a and/or network may refer to both the serving cell 205 IDs (and maybe in addition to PCIDs) for measurement purposes, radio resource monitoring, handovers, etc. As such, when the PCIDs of serving cells 205 of a vCell 210 are identical, then each serving cell may have a separate ID to avoid any confusion. Techniques for using masks may be only one option to indicate the cells of a vCell 210, where other linear or non-linear functions that take PCIDs of the serving cells 205 may also be used or defined.

After receiving all the subsets/portions of information required to determine the structure of the vCell 210 and to access the vCell 210, the UE 115-a may perform an attachment procedure in order to attach to and communicate with the vCell 210. For example, the UE 115-a may perform a RACH procedure with the vCell 210, where the UE 115-a is able to communicate with all the respective serving cells 205 of the vCell 210 upon successful completion of the RCH procedure.

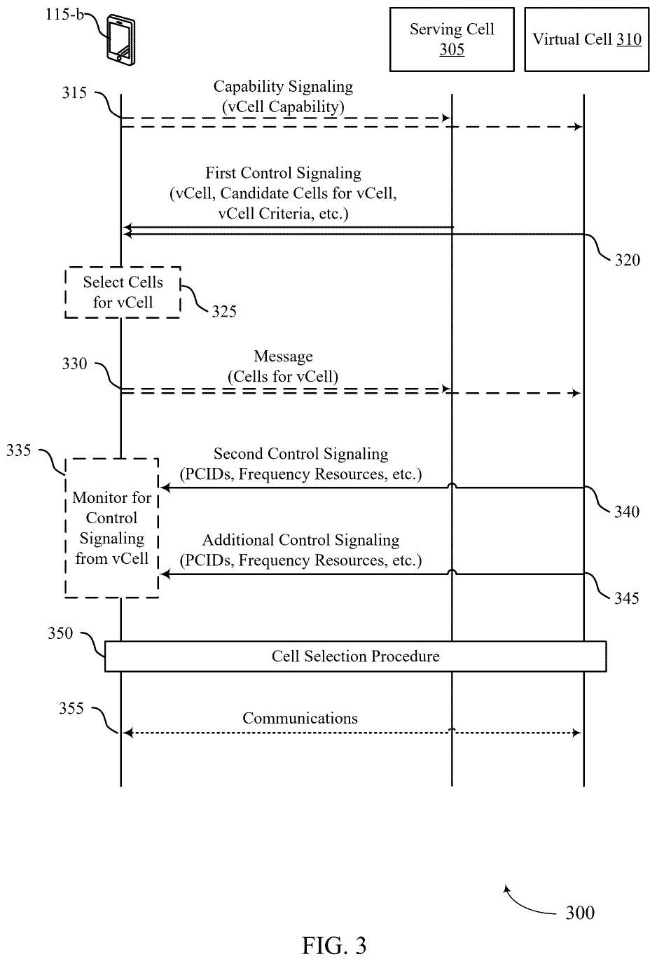

FIG. 3 shows an example of a process flow 300 that supports techniques for vCell configuration and indication in accordance with one or more aspects of the present disclosure. Aspects of the process flow 300 may implement, or be implemented by, aspects of the wireless communications system 100, the wireless communications system 200, or both. For example, the process flow 300 may support signaling and configurations used for configuration and indication of vCells within a wireless network, as described herein.

The process flow 300 includes a UE 115-b, a serving cell 305, and a vCell 310, which may be examples of cells and wireless devices as described herein. For example, the UE 115-b, the serving cell 305, and the vCell 310 illustrated in FIG. 3 may include examples of the UE 115-a, the serving cell 205-a, and the vCell 210, respectively, as illustrated in FIG. 2. In this regard, the serving cell 305 may be an example of a “standalone” cell, and the vCell 310 may include a set of serving cells (e.g., set of sub-bands, set of CCs, etc.) that are aggregated, bundled, or otherwise grouped to facilitate wireless communications.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 315, the UE 115-b may transmit capability signaling to the serving cell 305, the vCell 310, or both. In some aspects, the capability signaling may indicate a capability of the UE 115-b to communicate via vCells (e.g., a capability to support communications with vCells).

At signaling operation 320, the UE 115-b may receive control signaling from the serving cell 305, the vCell 310, or both. The UE 115-b may receive the control signaling based on transmitting the capability signaling via the signaling operation 315. In some aspects, the control signaling may indicate candidate vCells (e.g., vCell 310), and/or may indicate candidate serving cells that may be selected to form/configure a vCell 310. For example, in the context of network-selected vCells, the control signaling may indicate the vCell 310, and may indicate the set of serving cells that make up the vCell 310.

Conversely, in the context of UE-selected vCells, the control signaling may indicate candidate serving cells that may be selected/grouped by the UE 115-b to form a vCell 310. Similarly, for UE-selected vCells, the control signaling may indicate a set of criteria associated with selection of the vCell 310. The criteria may include rules, conditions, or other restrictions that the UE 115-b is to use to select the serving cells for a vCell 310. For example, the set of criteria may indicate one or more “mandatory” serving cells that must be selected for a vCell 310, or may indicate that the selected vCell 310 must include both uplink and downlink serving cells. For instance, the set of criteria may indicate subsets of serving cells that must be selected in order for the formed vCell 310 to be able to complete a RACH procedure.

At selection operation 325, the UE 115-b may select a set of serving cells that are to be aggregated, bundled, or otherwise grouped to form a vCell. The UE 115-b may select the serving cells for the vCell 310 from the set of candidate serving cells indicated via the signaling operation 315. In this regard, the selection operation 325 illustrates an example formation of a UE-selected vCell. Similarly, in the context of a network-selected vCell, the network may indicate a set of serving cells of the vCell 310, and the UE 115-b may select a subset of serving cells of the vCell that the UE 115-b is to attach to or otherwise communicate with.

As noted previously herein, the UE 115-b may select the serving cells of the vCell 310 in accordance with the set of criteria indicated via the signaling operation 315. For example, the set of criteria may indicate that a formed vCell 310 is to include at least one downlink serving cell and at least one uplink serving cell, or that a formed vCell 310 is to include serving cells within certain frequency bands or ranges. In other cases, the criteria may indicate a maximum or minimum quantity of serving cells that may be grouped in a vCell 310, a maximum/minimum bandwidth of the vCell 310, one or more “mandatory” serving cells that must be selected/included within a vCell 310, or any combination thereof.

At signaling operation 330, the UE 115-b may transmit a message to the serving cell 305, the vCell 310 (e.g., one or more cells/CCs of the vCell 310), or both, where the message indicates the set of serving cells selected via the selection operation 325. That is, in the case of a UE-selected vCell 310, the UE 115-b may indicate which serving cells are being aggregated/grouped to form the vCell 310.

At monitoring operation 335, the UE 115-b may monitor for control signaling from the vCell 310 (e.g., monitor for control signaling transmitted by one or more serving cells of the vCell 310). The UE 115-b may perform the monitoring operation 335 based on the signaling operations 315, 320, 330, the selection operation 325, or any combination thereof.

At signaling operation 340, the UE 115-b may receive second control signaling from a first serving cell of the set of serving cells of the vCell 310. The UE 115-b may receive the second control signaling based on the signaling operations 315, 320, 330, the selection operation 325, the monitoring operation 335, or any combination thereof. The second control signaling may include a CD-SSB associated with the vCell, a DRS associated with the vCell, a SIB (e.g., SIB1, SIB2, etc.) associated with the vCell 310, or any combination thereof.

In some aspects, the second control signaling may indicate a set of PCIDs associated with the set of serving cells of the vCell 310 (e.g., via one or more common bits). For example, the first control signaling, the second control signaling, or both, may indicate a binary mask associated with the vCell 310, where the UE 115-a is configured to identify the serving cells that are included within (e.g., make up) the vCell 310 based on the binary mask and the PCIDs of the respective serving cells. Additionally, or alternatively, the second control signaling may indicate a set of frequency resources associated with set of serving cells of the vCell 310, or both. For example, the second control signaling may indicate a set of ARFCNs associated with the respective serving cells of the vCell 310. In this regard, the second control signaling may include information that indicates the structure/format of the vCell 310, and information for communicating with the vCell 310.

As noted previously herein, in order to communicate with the vCell 310, the UE 115-b may be expected to receive multiple control messages/signaling (e.g., different subsets or segments of control information) from various serving cells of the vCell 310. In this regard, the control signaling may include a “next information field” and/or a “previous information field” that indicates additional control messages/signaling that is transmitted by the vCell 310. In other words, the control signaling may include information that indicates which subset/portion of control information is being communicated via the second control signaling.

For instance, if the “previous information field” is empty (or otherwise set to some predetermined/configured value), the UE 115-b may be able to determine that the second control signaling includes the initial (e.g., earliest, first) portion/subset of information for accessing the vCell 310. Otherwise, the “previous information field” may indicate resources for receiving the previous subset/portion of information for accessing the vCell 310. Conversely, if the “next information field” is empty (or otherwise set to some predetermined/configured value), the UE 115-b may be able to determine that the second control signaling includes the last portion/subset of information for accessing the vCell 310. Otherwise, the “next information field” may indicate resources for receiving the subsequent subset/portion of information for accessing the vCell 310. In this regard, the “previous information field” and the “next information field” may enable the UE 115-b to determine which subsets/portions of information are still needed in order to access the vCell 310

At signaling operation 345, the UE 115-b may receive additional control signaling from an additional serving cell of the set of serving cells of the vCell 310. The UE 115-b may receive the second control signaling based on the signaling operations 315, 320, 330, the selection operation 325, the monitoring operation 335, or any combination thereof. For example, the next information field within the second control signaling may indicate resources for receiving the additional control signaling at signaling operation 345. The additional control signaling may include a CD-SSB associated with the vCell, a DRS associated with the vCell, a SIB (e.g., SIB1, SIB2, etc.) associated with the vCell 310, or any combination thereof.

At cell attachment operation 350, the UE 115-b and the vCell 310 may perform a cell attachment procedure in order to allow the UE 115-b and the vCell 310 to communicate with one another. For example, as part of the cell attachment procedure, the UE 115-b and one or more serving cells of the vCell 310 may exchange signaling as part of a RACH procedure.

At signaling operation 355, the UE 115-b and the vCell 310 may communicate with one another. That is, the UE 115-b may communicate with the network via the one or more serving cells of the vCell 310.

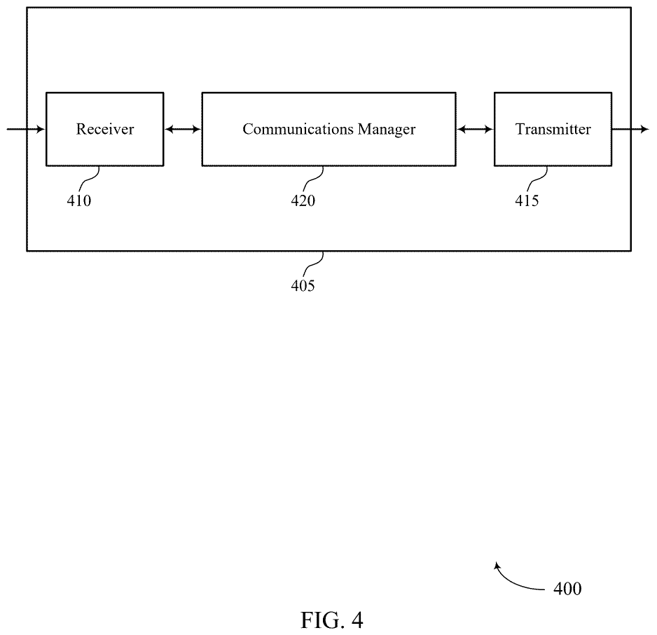

FIG. 4 shows a block diagram 400 of a device 405 that supports techniques for vCell configuration and indication in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for vCell configuration and indication). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for vCell configuration and indication). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for vCell configuration and indication as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving control signaling that indicates a vCell including a set of serving cells that are grouped together to facilitate wireless communication, a set of multiple candidate serving cells for selecting the set of serving cells of the vCell, or both. The communications manager 420 is capable of, configured to, or operable to support a means for monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both. The communications manager 420 is capable of, configured to, or operable to support a means for performing a cell selection procedure to access the set of serving cells of the vCell based on the second control signaling. The communications manager 420 is capable of, configured to, or operable to support a means for communicating with the set of serving cells of the vCell in accordance with successful performance of the cell selection procedure.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques that enable wireless devices (e.g., network entities 105, UEs 115, etc.) to efficiently form, configure, or otherwise create vCells within a wireless network. Further, techniques described herein may enable the network to communicate the existence and structure of formed vCells to enable UEs to attach and communicate with the vCells. By enabling providing mechanisms to create and indicate the existence/structure of vCells to UEs 115, aspects of the present disclosure may enable UEs 115 to attach and communicate with vCells that include with multiple serving cells, thereby increasing bandwidth and reducing latency, among other advantages.

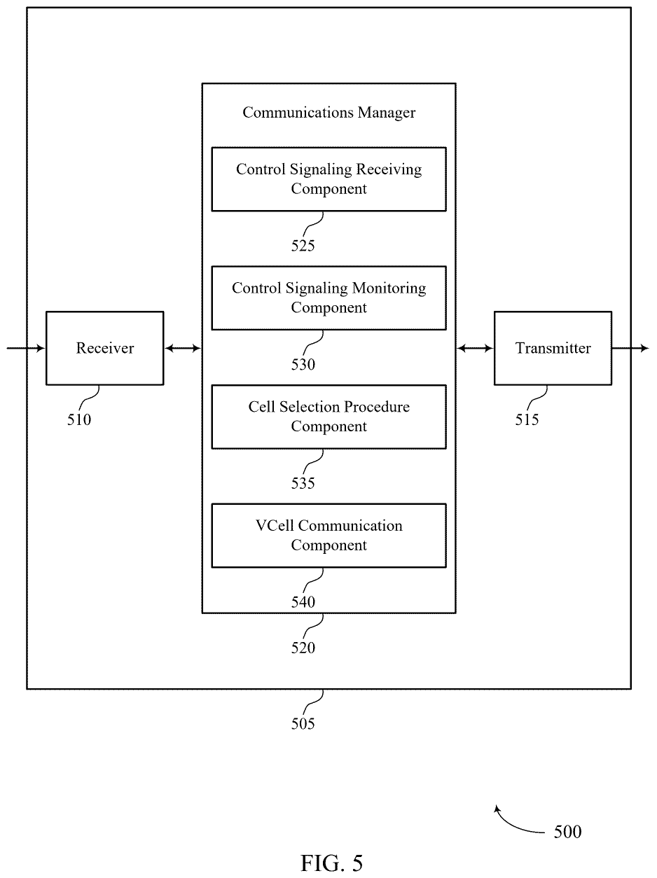

FIG. 5 shows a block diagram 500 of a device 505 that supports techniques for vCell configuration and indication in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for vCell configuration and indication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for vCell configuration and indication). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for vCell configuration and indication as described herein. For example, the communications manager 520 may include a control signaling receiving component 525, a control signaling monitoring component 530, a cell selection procedure component 535, a vCell communication component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The control signaling receiving component 525 is capable of, configured to, or operable to support a means for receiving control signaling that indicates a vCell including a set of serving cells that are grouped together to facilitate wireless communication, a set of multiple candidate serving cells for selecting the set of serving cells of the vCell, or both. The control signaling monitoring component 530 is capable of, configured to, or operable to support a means for monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both. The cell selection procedure component 535 is capable of, configured to, or operable to support a means for performing a cell selection procedure to access the set of serving cells of the vCell based on the second control signaling. The vCell communication component 540 is capable of, configured to, or operable to support a means for communicating with the set of serving cells of the vCell in accordance with successful performance of the cell selection procedure.

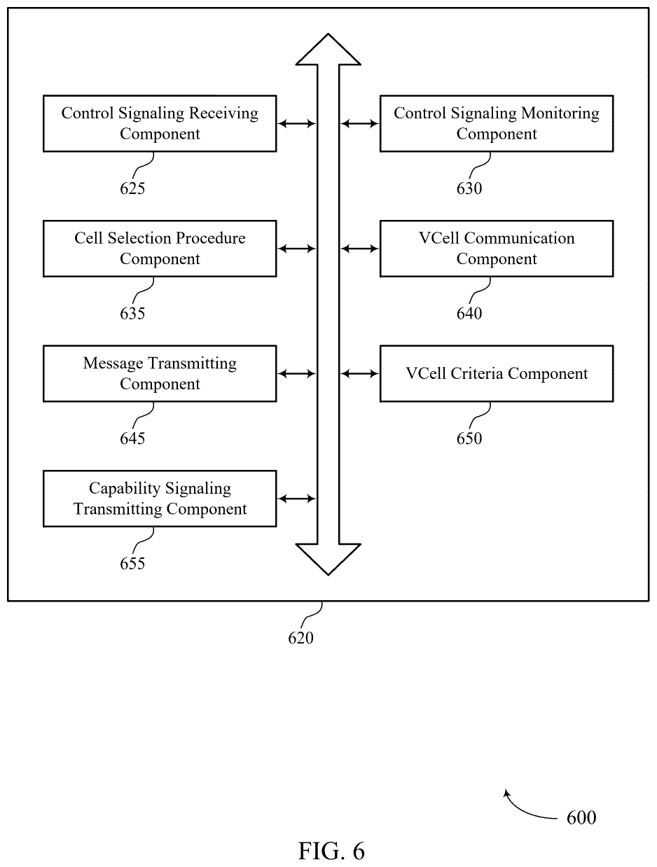

FIG. 6 shows a block diagram 600 of a communications manager 620 that supports techniques for vCell configuration and indication in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for vCell configuration and indication as described herein. For example, the communications manager 620 may include a control signaling receiving component 625, a control signaling monitoring component 630, a cell selection procedure component 635, a vCell communication component 640, a message transmitting component 645, a vCell criteria component 650, a capability signaling transmitting component 655, or any combination thereof. Each of these components, or components or subcomponents thereof (e.g., one or more processors, one or more memories), may communicate, directly or indirectly, with one another (e.g., via one or more buses).

The control signaling receiving component 625 is capable of, configured to, or operable to support a means for receiving control signaling that indicates a vCell including a set of serving cells that are grouped together to facilitate wireless communication, a set of multiple candidate serving cells for selecting the set of serving cells of the vCell, or both. The control signaling monitoring component 630 is capable of, configured to, or operable to support a means for monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both. The cell selection procedure component 635 is capable of, configured to, or operable to support a means for performing a cell selection procedure to access the set of serving cells of the vCell based on the second control signaling. The vCell communication component 640 is capable of, configured to, or operable to support a means for communicating with the set of serving cells of the vCell in accordance with successful performance of the cell selection procedure.

In some examples, the message transmitting component 645 is capable of, configured to, or operable to support a means for transmitting, based on the control signaling, a message indicating the set of serving cells from the set of multiple candidate serving cells for formation of the vCell, where monitoring for the second control signaling, performing the cell selection procedure with the vCell, or both, is based on transmitting the message.

In some examples, the message transmitting component 645 is capable of, configured to, or operable to support a means for transmitting, based on the control signaling, a message indicating a subset of serving cells from the set of serving cells for formation of the vCell, where the cell selection procedure is performed to access the subset of serving cells, and where communicating with the set of serving cells includes communicating with the subset of serving cells.

In some examples, the vCell criteria component 650 is capable of, configured to, or operable to support a means for receiving, via the control signaling, a set of criteria associated with a selection of the vCell. In some examples, the message transmitting component 645 is capable of, configured to, or operable to support a means for transmitting a message including an indication of the set of serving cells from the set of multiple candidate serving cells, an indication of a subset of serving cells from the set of serving cells, or both, where a selection of the set of serving cells from the set of multiple candidate serving cells, a selection of the subset of serving cells from the set of serving cells, or both, is performed in accordance with the set of criteria.

In some examples, the set of criteria include a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.

In some examples, the set of criteria include a criteria that at least one serving cell from the set of serving cells includes a mandatory serving cell for the vCell.

In some examples, the capability signaling transmitting component 655 is capable of, configured to, or operable to support a means for transmitting capability signaling indicating a capability of the UE to communicate via one or more vCells, where receiving the control signaling, monitoring for the second control signaling, or both, is based on transmitting the capability signaling.

In some examples, the second control signaling includes a cell-defining SSB associated with the vCell, a DRS associated with the vCell, a SIB associated with the vCell, or any combination thereof.

In some examples, the second control signaling includes a set of ARFCNs associated with the set of serving cells of the vCell.

In some examples, the control signaling monitoring component 630 is capable of, configured to, or operable to support a means for monitoring for the additional control signaling from the second serving cell of the vCell based on the next information field of the second control signaling, where performing the cell selection procedure, communicating with the set of serving cells of the vCell, or both, is based on the additional control signaling.

In some examples, a previous information field of the second control signaling indicates that the second control signaling includes an initial control signaling associated with the vCell. In some examples, a previous information field of the additional control signaling indicates the second control signaling.

In some examples, a next information field of the additional control signaling indicates either a subsequent control signaling associated with the vCell, or indicates that the additional control signaling is a final control signaling associated with the vCell.

In some examples, the set of PCIDs associated with the set of serving cells include one or more common bits based on the set of serving cells being associated with the vCell.

In some examples, the control signaling receiving component 625 is capable of, configured to, or operable to support a means for receiving, via the control signaling, the second control signaling, or both, a binary mask associated with the vCell. In some examples, the vCell communication component 640 is capable of, configured to, or operable to support a means for determining the set of serving cells associated with the vCell based on the set of PCIDs and the binary mask.

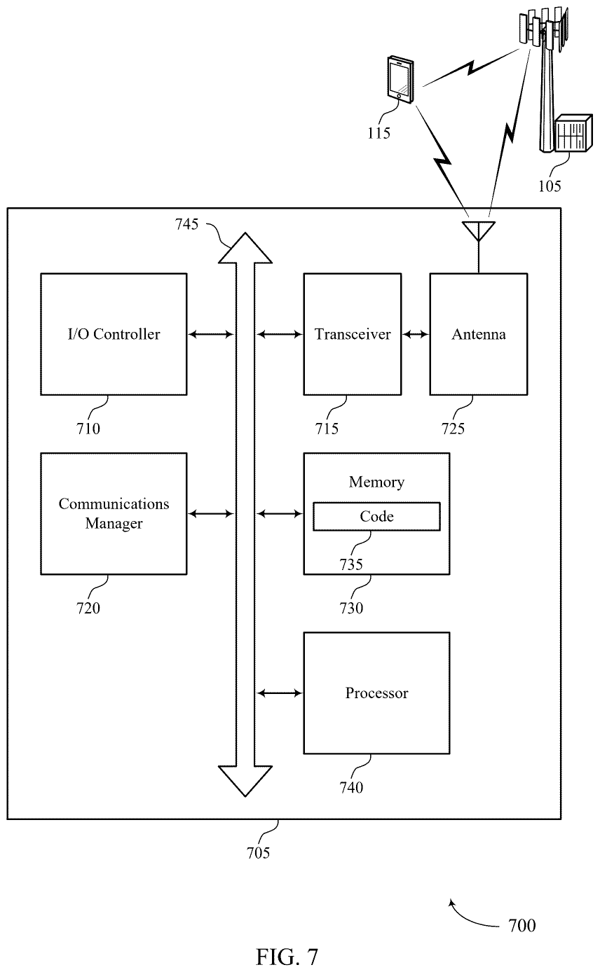

FIG. 7 shows a diagram of a system 700 including a device 705 that supports techniques for vCell configuration and indication in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for vCell configuration and indication). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving control signaling that indicates a vCell including a set of serving cells that are grouped together to facilitate wireless communication, a set of multiple candidate serving cells for selecting the set of serving cells of the vCell, or both. The communications manager 720 is capable of, configured to, or operable to support a means for monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both. The communications manager 720 is capable of, configured to, or operable to support a means for performing a cell selection procedure to access the set of serving cells of the vCell based on the second control signaling. The communications manager 720 is capable of, configured to, or operable to support a means for communicating with the set of serving cells of the vCell in accordance with successful performance of the cell selection procedure.

By including or configuring the communications manager 720 in accordance with examples as described herein, the device 705 may support techniques that enable wireless devices (e.g., network entities 105, UEs 115, etc.) to efficiently form, configure, or otherwise create vCells within a wireless network. Further, techniques described herein may enable the network to communicate the existence and structure of formed vCells to enable UEs to attach and communicate with the vCells. By enabling providing mechanisms to create and indicate the existence/structure of vCells to UEs 115, aspects of the present disclosure may enable UEs 115 to attach and communicate with vCells that include with multiple serving cells, thereby increasing bandwidth and reducing latency, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for vCell configuration and indication as described herein, or the at least one processor 740 and the at least one memory 730 may be otherwise configured to, individually or collectively, perform or support such operations.

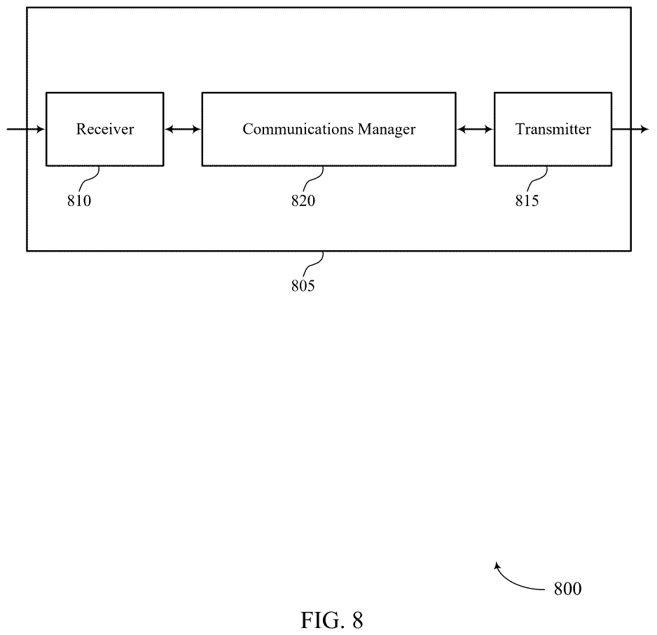

FIG. 8 shows a block diagram 800 of a device 805 that supports techniques for vCell configuration and indication in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for vCell configuration and indication as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for outputting control signaling that indicates a vCell including a set of serving cells that are grouped together to facilitate wireless communication, a set of multiple candidate serving cells for selecting the set of serving cells of the vCell, or both. The communications manager 820 is capable of, configured to, or operable to support a means for outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both. The communications manager 820 is capable of, configured to, or operable to support a means for performing a cell selection procedure with a UE to enable the UE to access the set of serving cells of the vCell based on the second control signaling. The communications manager 820 is capable of, configured to, or operable to support a means for communicating with the UE via the set of serving cells of the vCell in accordance with successful performance of the cell selection procedure.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques that enable wireless devices (e.g., network entities 105, UEs 115, etc.) to efficiently form, configure, or otherwise create vCells within a wireless network. Further, techniques described herein may enable the network to communicate the existence and structure of formed vCells to enable UEs to attach and communicate with the vCells. By enabling providing mechanisms to create and indicate the existence/structure of vCells to UEs 115, aspects of the present disclosure may enable UEs 115 to attach and communicate with vCells that include with multiple serving cells, thereby increasing bandwidth and reducing latency, among other advantages.

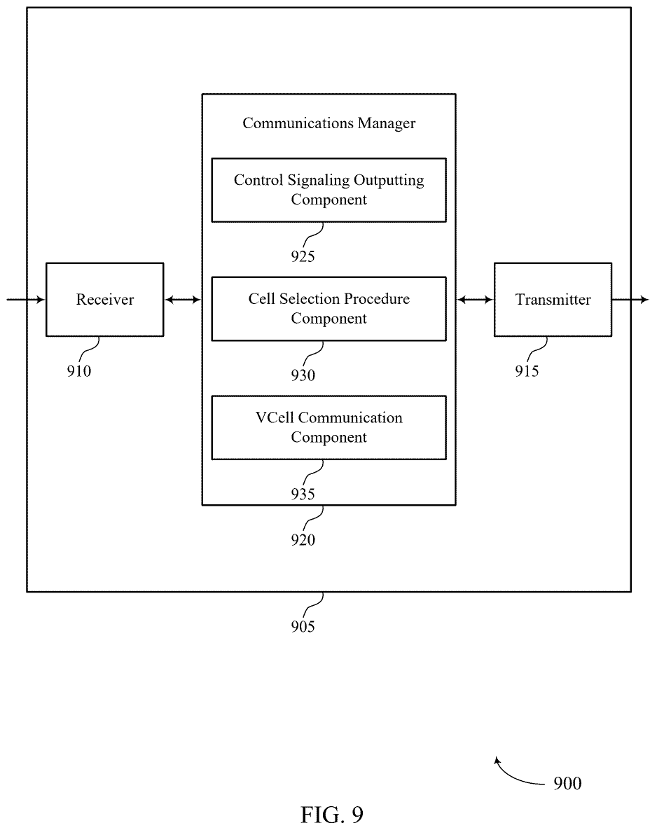

FIG. 9 shows a block diagram 900 of a device 905 that supports techniques for vCell configuration and indication in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for vCell configuration and indication as described herein. For example, the communications manager 920 may include a control signaling outputting component 925, a cell selection procedure component 930, a vCell communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The control signaling outputting component 925 is capable of, configured to, or operable to support a means for outputting control signaling that indicates a vCell including a set of serving cells that are grouped together to facilitate wireless communication, a set of multiple candidate serving cells for selecting the set of serving cells of the vCell, or both. The control signaling outputting component 925 is capable of, configured to, or operable to support a means for outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both. The cell selection procedure component 930 is capable of, configured to, or operable to support a means for performing a cell selection procedure with a UE to enable the UE to access the set of serving cells of the vCell based on the second control signaling. The vCell communication component 935 is capable of, configured to, or operable to support a means for communicating with the UE via the set of serving cells of the vCell in accordance with successful performance of the cell selection procedure.

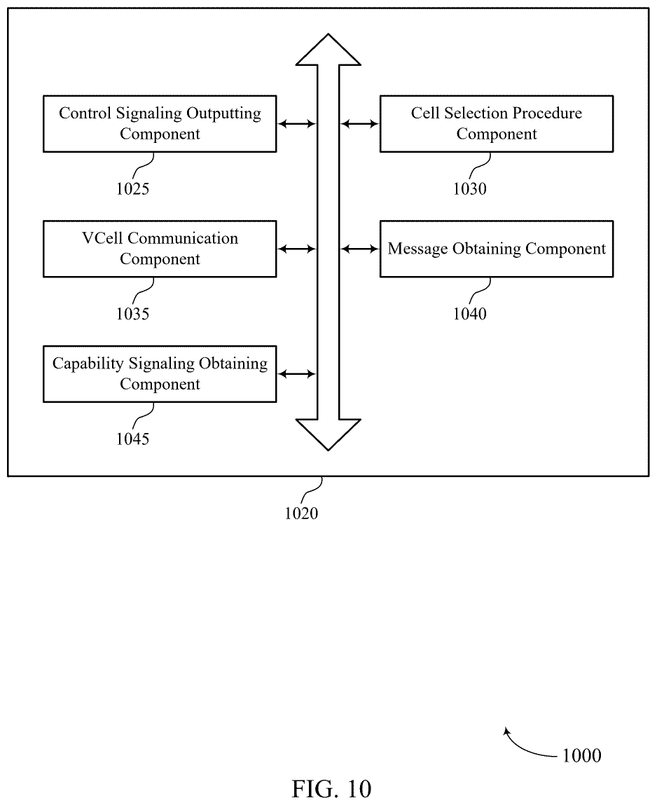

FIG. 10 shows a block diagram 1000 of a communications manager 1020 that supports techniques for vCell configuration and indication in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for vCell configuration and indication as described herein. For example, the communications manager 1020 may include a control signaling outputting component 1025, a cell selection procedure component 1030, a vCell communication component 1035, a message obtaining component 1040, a capability signaling obtaining component 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control signaling outputting component 1025 is capable of, configured to, or operable to support a means for outputting control signaling that indicates a vCell including a set of serving cells that are grouped together to facilitate wireless communication, a set of multiple candidate serving cells for selecting the set of serving cells of the vCell, or both. In some examples, the control signaling outputting component 1025 is capable of, configured to, or operable to support a means for outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both. The cell selection procedure component 1030 is capable of, configured to, or operable to support a means for performing a cell selection procedure with a UE to enable the UE to access the set of serving cells of the vCell based on the second control signaling. The vCell communication component 1035 is capable of, configured to, or operable to support a means for communicating with the UE via the set of serving cells of the vCell in accordance with successful performance of the cell selection procedure.

In some examples, the message obtaining component 1040 is capable of, configured to, or operable to support a means for obtaining, based on the control signaling, a message indicating the set of serving cells from the set of multiple candidate serving cells for formation of the vCell, where outputting the second control signaling, performing the cell selection procedure with the UE, or both, is based on obtaining the message.

In some examples, the message obtaining component 1040 is capable of, configured to, or operable to support a means for obtaining, based on the control signaling, a message indicating a subset of serving cells from the set of serving cells for formation of the vCell, where the cell selection procedure is performed to enable the UE to access the subset of serving cells, and where communicating with the UE via the set of serving cells includes communicating via the subset of serving cells.

In some examples, the control signaling outputting component 1025 is capable of, configured to, or operable to support a means for outputting, via the control signaling, a set of criteria associated with a selection of the vCell. In some examples, the message obtaining component 1040 is capable of, configured to, or operable to support a means for obtaining a message including an indication of the set of serving cells from the set of multiple candidate serving cells, an indication of a subset of serving cells from the set of serving cells, or both, where a selection of the set of serving cells from the set of multiple candidate serving cells, a selection of the subset of serving cells from the set of serving cells, or both, is performed in accordance with the set of criteria.

In some examples, the set of criteria include a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.

In some examples, the set of criteria include a criteria that at least one serving cell from the set of serving cells includes a mandatory serving cell for the vCell.

In some examples, the capability signaling obtaining component 1045 is capable of, configured to, or operable to support a means for obtaining capability signaling indicating a capability of the UE to communicate via one or more vCells, where outputting the control signaling, outputting for the second control signaling, or both, is based on obtaining the capability signaling.

In some examples, the second control signaling includes a cell-defining SSB associated with the vCell, a DRS associated with the vCell, a SIB associated with the vCell, or any combination thereof.

In some examples, the second control signaling includes a set of ARFCNs associated with the set of serving cells of the vCell.

In some examples, the control signaling outputting component 1025 is capable of, configured to, or operable to support a means for outputting the additional control signaling via the second serving cell of the vCell based on the next information field of the second control signaling, where performing the cell selection procedure, communicating with the UE via the set of serving cells of the vCell, or both, is based on the additional control signaling.

In some examples, a previous information field of the second control signaling indicates that the second control signaling includes an initial control signaling associated with the vCell. In some examples, a previous information field of the additional control signaling indicates the second control signaling.

In some examples, a next information field of the additional control signaling indicates either a subsequent control signaling associated with the vCell, or indicates that the additional control signaling is a final control signaling associated with the vCell.

In some examples, the set of PCIDs associated with the set of serving cells include one or more common bits based on the set of serving cells being associated with the vCell.

In some examples, the control signaling outputting component 1025 is capable of, configured to, or operable to support a means for outputting, via the control signaling, the second control signaling, or both, a binary mask associated with the vCell, where the set of serving cells associated with the vCell are determined based on the set of PCIDs and the binary mask.

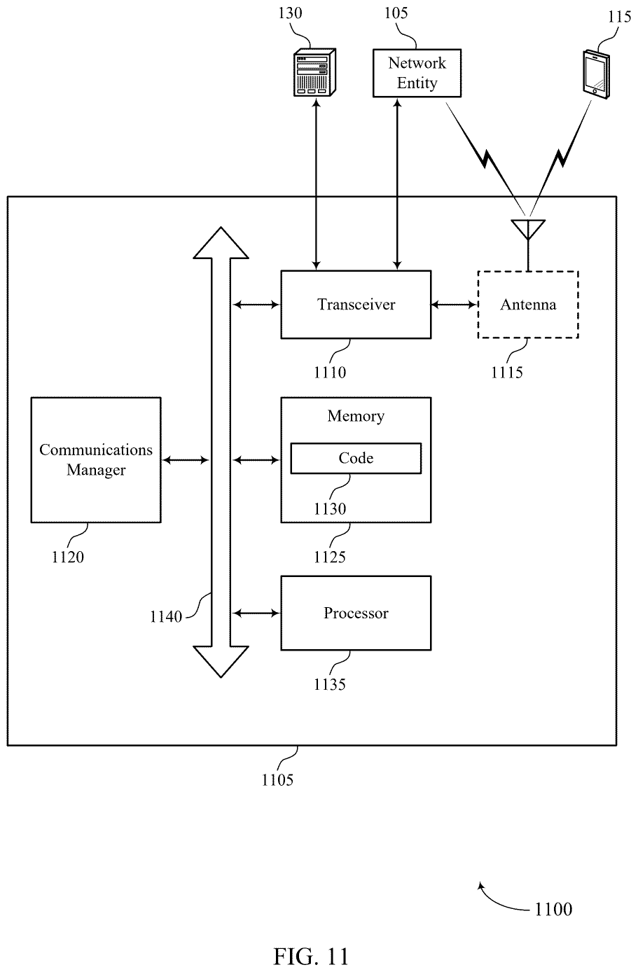

FIG. 11 shows a diagram of a system 1100 including a device 1105 that supports techniques for vCell configuration and indication in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for vCell configuration and indication). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

For example, the communications manager 1120 is capable of, configured to, or operable to support a means for outputting control signaling that indicates a vCell including a set of serving cells that are grouped together to facilitate wireless communication, a set of multiple candidate serving cells for selecting the set of serving cells of the vCell, or both. The communications manager 1120 is capable of, configured to, or operable to support a means for outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both. The communications manager 1120 is capable of, configured to, or operable to support a means for performing a cell selection procedure with a UE to enable the UE to access the set of serving cells of the vCell based on the second control signaling. The communications manager 1120 is capable of, configured to, or operable to support a means for communicating with the UE via the set of serving cells of the vCell in accordance with successful performance of the cell selection procedure.

By including or configuring the communications manager 1120 in accordance with examples as described herein, the device 1105 may support techniques that enable wireless devices (e.g., network entities 105, UEs 115, etc.) to efficiently form, configure, or otherwise create vCells within a wireless network. Further, techniques described herein may enable the network to communicate the existence and structure of formed vCells to enable UEs to attach and communicate with the vCells. By enabling providing mechanisms to create and indicate the existence/structure of vCells to UEs 115, aspects of the present disclosure may enable UEs 115 to attach and communicate with vCells that include with multiple serving cells, thereby increasing bandwidth and reducing latency, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for vCell configuration and indication as described herein, or the at least one processor 1135 and the at least one memory 1125 may be otherwise configured to, individually or collectively, perform or support such operations.

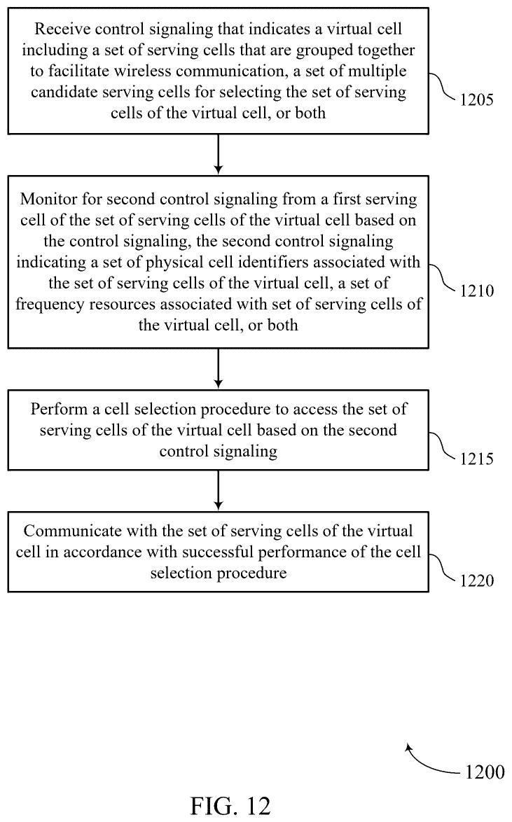

FIG. 12 shows a flowchart illustrating a method 1200 that supports techniques for vCell configuration and indication in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling that indicates a vCell including a set of serving cells that are grouped together to facilitate wireless communication, a set of multiple candidate serving cells for selecting the set of serving cells of the vCell, or both. The operations of 1205 may be performed in accordance with examples as disclosed herein. In some examples, aspects of the operations of 1205 may be performed by a control signaling receiving component 625 as described with reference to FIG. 6.

At 1210, the method may include monitoring for second control signaling from a first serving cell of the set of serving cells of the vCell based on the control signaling, the second control signaling indicating a set of PCIDs associated with the set of serving cells of the vCell, a set of frequency resources associated with set of serving cells of the vCell, or both. The operations of 1210 may be performed in accordance with examples as disclosed herein. In some examples, aspects of the operations of 1210 may be performed by a control signaling monitoring component 630 as described with reference to FIG. 6.

At 1215, the method may include performing a cell selection procedure to access the set of serving cells of the vCell based on the second control signaling. The operations of 1215 may be performed in accordance with examples as disclosed herein. In some examples, aspects of the operations of 1215 may be performed by a cell selection procedure component 635 as described with reference to FIG. 6.

At 1220, the method may include communicating with the set of serving cells of the vCell in accordance with successful performance of the cell selection procedure. The operations of 1220 may be performed in accordance with examples as disclosed herein. In some examples, aspects of the operations of 1220 may be performed by a vCell communication component 640 as described with reference to FIG. 6.

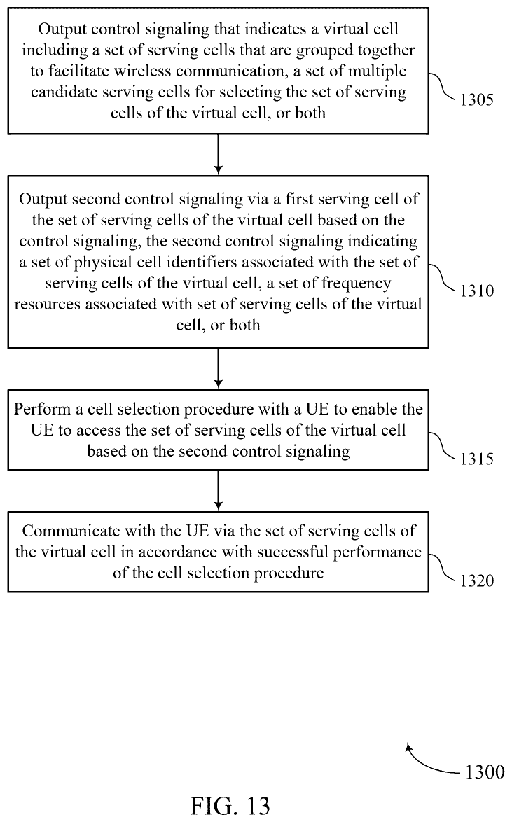

FIG. 13 shows a flowchart illustrating a method 1300 that supports techniques for vCell configuration and indication in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting control signaling that indicates a vCell including a set of serving cells that are grouped together to facilitate wireless communication, a set of multiple candidate serving cells for selecting the set of serving cells of the vCell, or both. The operations of 1305 may be performed in accordance with examples as disclosed herein. In some examples, aspects of the operations of 1305 may be performed by a control signaling outputting component 1025 as described with reference to FIG. 10.

At 1310, the method may include outputting second control signaling via a first serving cell of the set of serving cells of the vCell based on the control signaling, the second control signaling indicating a set of PCIDs associated with the set of serving cells of the vCell, a set of frequency resources associated with set of serving cells of the vCell, or both. The operations of 1310 may be performed in accordance with examples as disclosed herein. In some examples, aspects of the operations of 1310 may be performed by a control signaling outputting component 1025 as described with reference to FIG. 10.

At 1315, the method may include performing a cell selection procedure with a UE to enable the UE to access the set of serving cells of the vCell based on the second control signaling. The operations of 1315 may be performed in accordance with examples as disclosed herein. In some examples, aspects of the operations of 1315 may be performed by a cell selection procedure component 1030 as described with reference to FIG. 10.

At 1320, the method may include communicating with the UE via the set of serving cells of the vCell in accordance with successful performance of the cell selection procedure. The operations of 1320 may be performed in accordance with examples as disclosed herein. In some examples, aspects of the operations of 1320 may be performed by a vCell communication component 1035 as described with reference to FIG. 10.

The following provides an overview of aspects of the present disclosure:
Aspect 1: A method for wireless communications at a UE, comprising: receiving control signaling that indicates a vCell comprising a set of serving cells that are grouped together to facilitate wireless communication, a plurality of candidate serving cells for selecting the set of serving cells of the vCell, or both; monitoring for second control signaling from a first serving cell of the set of serving cells of the vCell based at least in part on the control signaling, the second control signaling indicating a set of PCIDs associated with the set of serving cells of the vCell, a set of frequency resources associated with set of serving cells of the vCell, or both; performing a cell selection procedure to access the set of serving cells of the vCell based at least in part on the second control signaling; and communicating with the set of serving cells of the vCell in accordance with successful performance of the cell selection procedure.
Aspect 2: The method of aspect 1, further comprising: transmitting, based at least in part on the control signaling, a message indicating the set of serving cells from the plurality of candidate serving cells for formation of the vCell, wherein monitoring for the second control signaling, performing the cell selection procedure with the vCell, or both, is based at least in part on transmitting the message.
Aspect 3: The method of any of aspects 1 through 2, further comprising: transmitting, based at least in part on the control signaling, a message indicating a subset of serving cells from the set of serving cells for formation of the vCell, wherein the cell selection procedure is performed to access the subset of serving cells, and wherein communicating with the set of serving cells comprises communicating with the subset of serving cells.
Aspect 4: The method of any of aspects 1 through 3, further comprising: receiving, via the control signaling, a set of criteria associated with a selection of the vCell; and transmitting a message comprising an indication of the set of serving cells from the plurality of candidate serving cells, an indication of a subset of serving cells from the set of serving cells, or both, wherein a selection of the set of serving cells from the plurality of candidate serving cells, a selection of the subset of serving cells from the set of serving cells, or both, is performed in accordance with the set of criteria.
Aspect 5: The method of aspect 4, wherein the set of criteria comprise a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.
Aspect 6: The method of any of aspects 4 through 5, wherein the set of criteria comprise a criteria that at least one serving cell from the set of serving cells comprises a mandatory serving cell for the vCell.
Aspect 7: The method of any of aspects 1 through 6, further comprising: transmitting capability signaling indicating a capability of the UE to communicate via one or more vCells, wherein receiving the control signaling, monitoring for the second control signaling, or both, is based at least in part on transmitting the capability signaling.
Aspect 8: The method of any of aspects 1 through 7, wherein the second control signaling comprises a cell-defining synchronization signal block associated with the vCell, a discovery reference signal associated with the vCell, a system information block associated with the vCell, or any combination thereof.
Aspect 9: The method of any of aspects 1 through 8, wherein the second control signaling comprises a set of ARFCNs associated with the set of serving cells of the vCell.
Aspect 10: The method of any of aspects 1 through 9, wherein the second control signaling includes a next information field that indicates additional control signaling transmitted by a second serving cell of the set of serving cells of the vCell, the method further comprising: monitoring for the additional control signaling from the second serving cell of the vCell based at least in part on the next information field of the second control signaling, wherein performing the cell selection procedure, communicating with the set of serving cells of the vCell, or both, is based at least in part on the additional control signaling.
Aspect 11: The method of aspect 10, wherein a previous information field of the second control signaling indicates that the second control signaling comprises an initial control signaling associated with the vCell, a previous information field of the additional control signaling indicates the second control signaling.
Aspect 12: The method of aspect 11, wherein a next information field of the additional control signaling indicates either a subsequent control signaling associated with the vCell, or indicates that the additional control signaling is a final control signaling associated with the vCell.
Aspect 13: The method of any of aspects 1 through 12, wherein the set of PCIDs associated with the set of serving cells comprise one or more common bits based at least in part on the set of serving cells being associated with the vCell.
Aspect 14: The method of any of aspects 1 through 13, further comprising: receiving, via the control signaling, the second control signaling, or both, a binary mask associated with the vCell; and determining the set of serving cells associated with the vCell based at least in part on the set of PCIDs and the binary mask.
Aspect 15: A method for wireless communications at a network entity, comprising: outputting control signaling that indicates a vCell comprising a set of serving cells that are grouped together to facilitate wireless communication, a plurality of candidate serving cells for selecting the set of serving cells of the vCell, or both; outputting second control signaling via a first serving cell of the set of serving cells of the vCell based at least in part on the control signaling, the second control signaling indicating a set of PCIDs associated with the set of serving cells of the vCell, a set of frequency resources associated with set of serving cells of the vCell, or both; performing a cell selection procedure with a UE to enable the UE to access the set of serving cells of the vCell based at least in part on the second control signaling; and communicating with the UE via the set of serving cells of the vCell in accordance with successful performance of the cell selection procedure.
Aspect 16: The method of aspect 15, further comprising: obtaining, based at least in part on the control signaling, a message indicating the set of serving cells from the plurality of candidate serving cells for formation of the vCell, wherein outputting the second control signaling, performing the cell selection procedure with the UE, or both, is based at least in part on obtaining the message.
Aspect 17: The method of any of aspects 15 through 16, further comprising: obtaining, based at least in part on the control signaling, a message indicating a subset of serving cells from the set of serving cells for formation of the vCell, wherein the cell selection procedure is performed to enable the UE to access the subset of serving cells, and wherein communicating with the UE via the set of serving cells comprises communicating via the subset of serving cells.
Aspect 18: The method of any of aspects 15 through 17, further comprising: outputting, via the control signaling, a set of criteria associated with a selection of the vCell; and obtaining a message comprising an indication of the set of serving cells from the plurality of candidate serving cells, an indication of a subset of serving cells from the set of serving cells, or both, wherein a selection of the set of serving cells from the plurality of candidate serving cells, a selection of the subset of serving cells from the set of serving cells, or both, is performed in accordance with the set of criteria.
Aspect 19: The method of aspect 18, wherein the set of criteria comprise a first criteria for the vCell to include at least one downlink serving cell and at least one uplink serving cell, a second criteria associated with one or more frequency bands for the vCell, a third criteria associated with a minimum or maximum quantity of serving cells of the vCell, a fourth criteria associated with a bandwidth of the vCell, a fifth criteria that at least one serving cell of the vCell transmits the second control signaling, or any combination thereof.
Aspect 20: The method of any of aspects 18 through 19, wherein the set of criteria comprise a criteria that at least one serving cell from the set of serving cells comprises a mandatory serving cell for the vCell.
Aspect 21: The method of any of aspects 15 through 20, further comprising: obtaining capability signaling indicating a capability of the UE to communicate via one or more vCells, wherein outputting the control signaling, outputting for the second control signaling, or both, is based at least in part on obtaining the capability signaling.
Aspect 22: The method of any of aspects 15 through 21, wherein the second control signaling comprises a cell-defining synchronization signal block associated with the vCell, a discovery reference signal associated with the vCell, a system information block associated with the vCell, or any combination thereof.
Aspect 23: The method of any of aspects 15 through 22, wherein the second control signaling comprises a set of ARFCNs associated with the set of serving cells of the vCell.
Aspect 24: The method of any of aspects 15 through 23, wherein the second control signaling includes a next information field that indicates additional control signaling communicated via a second serving cell of the set of serving cells of the vCell, the method further comprising: outputting the additional control signaling via the second serving cell of the vCell based at least in part on the next information field of the second control signaling, wherein performing the cell selection procedure, communicating with the UE via the set of serving cells of the vCell, or both, is based at least in part on the additional control signaling.
Aspect 25: The method of aspect 24, wherein a previous information field of the second control signaling indicates that the second control signaling comprises an initial control signaling associated with the vCell, a previous information field of the additional control signaling indicates the second control signaling.
Aspect 26: The method of aspect 25, wherein a next information field of the additional control signaling indicates either a subsequent control signaling associated with the vCell, or indicates that the additional control signaling is a final control signaling associated with the vCell.
Aspect 27: The method of any of aspects 15 through 26, wherein the set of PCIDs associated with the set of serving cells comprise one or more common bits based at least in part on the set of serving cells being associated with the vCell.
Aspect 28: The method of any of aspects 15 through 27, further comprising: outputting, via the control signaling, the second control signaling, or both, a binary mask associated with the vCell, wherein the set of serving cells associated with the vCell are determined based at least in part on the set of PCIDs and the binary mask.
Aspect 29: A UE comprising one or more memories storing processor-executable code, and one or more processors coupled with the one or more memories and individually or collectively operable to execute the code to cause the UE to perform a method of any of aspects 1 through 14.
Aspect 30: A UE comprising at least one means for performing a method of any of aspects 1 through 14.
Aspect 31: A non-transitory computer-readable medium storing code the code comprising instructions executable by one or more processors to perform a method of any of aspects 1 through 14.
Aspect 32: A network entity comprising one or more memories storing processor-executable code, and one or more processors coupled with the one or more memories and individually or collectively operable to execute the code to cause the network entity to perform a method of any of aspects 15 through 28.
Aspect 33: A network entity comprising at least one means for performing a method of any of aspects 15 through 28.
Aspect 34: A non-transitory computer-readable medium storing code the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a virtual cell comprising a set of serving cells that are grouped together to facilitate wireless communication, a plurality of candidate serving cells for selecting the set of serving cells of the virtual cell, or both;
monitor for second control signaling from a first serving cell of the set of serving cells of the virtual cell based at least in part on the control signaling, the second control signaling indicating a set of physical cell identifiers associated with the set of serving cells of the virtual cell, a set of frequency resources associated with set of serving cells of the virtual cell, or both;
perform a cell selection procedure to access the set of serving cells of the virtual cell based at least in part on the second control signaling; and
communicate with the set of serving cells of the virtual cell in accordance with successful performance of the cell selection procedure.

2. The UE of claim 1, wherein the one or more processors are individually or collectively further operable to execute the code to cause the UE to:
transmit, based at least in part on the control signaling, a message indicating the set of serving cells from the plurality of candidate serving cells for formation of the virtual cell, wherein monitoring for the second control signaling, performing the cell selection procedure with the virtual cell, or both, is based at least in part on transmitting the message.

3. The UE of claim 1, wherein the one or more processors are individually or collectively further operable to execute the code to cause the UE to:
transmit, based at least in part on the control signaling, a message indicating a subset of serving cells from the set of serving cells for formation of the virtual cell, wherein the cell selection procedure is performed to access the subset of serving cells, and wherein communicating with the set of serving cells comprises communicating with the subset of serving cells.

4. The UE of claim 1, wherein the one or more processors are individually or collectively further operable to execute the code to cause the UE to:
receive, via the control signaling, a set of criteria associated with a selection of the virtual cell; and
transmit a message comprising an indication of the set of serving cells from the plurality of candidate serving cells, an indication of a subset of serving cells from the set of serving cells, or both, wherein a selection of the set of serving cells from the plurality of candidate serving cells, a selection of the subset of serving cells from the set of serving cells, or both, is performed in accordance with the set of criteria.

5. The UE of claim 4, wherein the set of criteria comprise a first criteria for the virtual cell to include at least one downlink serving cell and at least one uplink serving cell, a second criteria associated with one or more frequency bands for the virtual cell, a third criteria associated with a minimum or maximum quantity of serving cells of the virtual cell, a fourth criteria associated with a bandwidth of the virtual cell, a fifth criteria that at least one serving cell of the virtual cell transmits the second control signaling, or any combination thereof.

6. The UE of claim 4, wherein the set of criteria comprise a criteria that at least one serving cell from the set of serving cells comprises a mandatory serving cell for the virtual cell.

7. The UE of claim 1, wherein the one or more processors are individually or collectively further operable to execute the code to cause the UE to:
transmit capability signaling indicating a capability of the UE to communicate via one or more virtual cells, wherein receiving the control signaling, monitoring for the second control signaling, or both, is based at least in part on transmitting the capability signaling.

8. The UE of claim 1, wherein the second control signaling comprises a cell-defining synchronization signal block associated with the virtual cell, a discovery reference signal associated with the virtual cell, a system information block associated with the virtual cell, or any combination thereof.

9. The UE of claim 1, wherein the second control signaling comprises a set of absolute radio frequency channel numbers associated with the set of serving cells of the virtual cell.

10. The UE of claim 1, wherein the second control signaling includes a next information field that indicates additional control signaling transmitted by a second serving cell of the set of serving cells of the virtual cell, wherein the one or more processors are individually or collectively further operable to execute the code to cause the UE to:
monitor for the additional control signaling from the second serving cell of the virtual cell based at least in part on the next information field of the second control signaling, wherein performing the cell selection procedure, communicating with the set of serving cells of the virtual cell, or both, is based at least in part on the additional control signaling.

11. The UE of claim 10, wherein a previous information field of the second control signaling indicates that the second control signaling comprises an initial control signaling associated with the virtual cell, wherein a previous information field of the additional control signaling indicates the second control signaling.

12. The UE of claim 11, wherein a next information field of the additional control signaling indicates either a subsequent control signaling associated with the virtual cell, or indicates that the additional control signaling is a final control signaling associated with the virtual cell.

13. The UE of claim 1, wherein the set of physical cell identifiers associated with the set of serving cells comprise one or more common bits based at least in part on the set of serving cells being associated with the virtual cell.

14. The UE of claim 1, wherein the one or more processors are individually or collectively further operable to execute the code to cause the UE to:
receive, via the control signaling, the second control signaling, or both, a binary mask associated with the virtual cell; and
determine the set of serving cells associated with the virtual cell based at least in part on the set of physical cell identifiers and the binary mask.

15. A network entity, comprising:
one or more memories storing processor-executable code; and
one or more processors coupled with the one or more memories and individually or collectively operable to execute the code to cause the network entity to:
output control signaling that indicates a virtual cell comprising a set of serving cells that are grouped together to facilitate wireless communication, a plurality of candidate serving cells for selecting the set of serving cells of the virtual cell, or both;
output second control signaling via a first serving cell of the set of serving cells of the virtual cell based at least in part on the control signaling, the second control signaling indicating a set of physical cell identifiers associated with the set of serving cells of the virtual cell, a set of frequency resources associated with set of serving cells of the virtual cell, or both;
perform a cell selection procedure with a user equipment (UE) to enable the UE to access the set of serving cells of the virtual cell based at least in part on the second control signaling; and
communicate with the UE via the set of serving cells of the virtual cell in accordance with successful performance of the cell selection procedure.

16. The network entity of claim 15, wherein the one or more processors are individually or collectively further operable to execute the code to cause the network entity to:
obtain, based at least in part on the control signaling, a message indicating the set of serving cells from the plurality of candidate serving cells for formation of the virtual cell, wherein outputting the second control signaling, performing the cell selection procedure with the UE, or both, is based at least in part on obtaining the message.

17. The network entity of claim 15, wherein the one or more processors are individually or collectively further operable to execute the code to cause the network entity to:
obtain, based at least in part on the control signaling, a message indicating a subset of serving cells from the set of serving cells for formation of the virtual cell, wherein the cell selection procedure is performed to enable the UE to access the subset of serving cells, and wherein communicating with the UE via the set of serving cells comprises communicating via the subset of serving cells.

18. The network entity of claim 15, wherein the one or more processors are individually or collectively further operable to execute the code to cause the network entity to:
output, via the control signaling, a set of criteria associated with a selection of the virtual cell; and
obtain a message comprising an indication of the set of serving cells from the plurality of candidate serving cells, an indication of a subset of serving cells from the set of serving cells, or both, wherein a selection of the set of serving cells from the plurality of candidate serving cells, a selection of the subset of serving cells from the set of serving cells, or both, is performed in accordance with the set of criteria.

19. The network entity of claim 18, wherein the set of criteria comprise a first criteria for the virtual cell to include at least one downlink serving cell and at least one uplink serving cell, a second criteria associated with one or more frequency bands for the virtual cell, a third criteria associated with a minimum or maximum quantity of serving cells of the virtual cell, a fourth criteria associated with a bandwidth of the virtual cell, a fifth criteria that at least one serving cell of the virtual cell transmits the second control signaling, or any combination thereof.

20. The network entity of claim 18, wherein the set of criteria comprise a criteria that at least one serving cell from the set of serving cells comprises a mandatory serving cell for the virtual cell.

21. The network entity of claim 15, wherein the one or more processors are individually or collectively further operable to execute the code to cause the network entity to:
obtain capability signaling indicating a capability of the UE to communicate via one or more virtual cells, wherein outputting the control signaling, outputting for the second control signaling, or both, is based at least in part on obtaining the capability signaling.

22. The network entity of claim 15, wherein the second control signaling comprises a cell-defining synchronization signal block associated with the virtual cell, a discovery reference signal associated with the virtual cell, a system information block associated with the virtual cell, or any combination thereof.

23. The network entity of claim 15, wherein the second control signaling comprises a set of absolute radio frequency channel numbers associated with the set of serving cells of the virtual cell.

24. The network entity of claim 15, wherein the second control signaling includes a next information field that indicates additional control signaling communicated via a second serving cell of the set of serving cells of the virtual cell, wherein the one or more processors are individually or collectively further operable to execute the code to cause the network entity to:
output the additional control signaling via the second serving cell of the virtual cell based at least in part on the next information field of the second control signaling, wherein performing the cell selection procedure, communicating with the UE via the set of serving cells of the virtual cell, or both, is based at least in part on the additional control signaling.

25. The network entity of claim 24, wherein a previous information field of the second control signaling indicates that the second control signaling comprises an initial control signaling associated with the virtual cell, wherein a previous information field of the additional control signaling indicates the second control signaling.

26. The network entity of claim 25, wherein a next information field of the additional control signaling indicates either a subsequent control signaling associated with the virtual cell, or indicates that the additional control signaling is a final control signaling associated with the virtual cell.

27. The network entity of claim 15, wherein the set of physical cell identifiers associated with the set of serving cells comprise one or more common bits based at least in part on the set of serving cells being associated with the virtual cell.

28. The network entity of claim 15, wherein the one or more processors are individually or collectively further operable to execute the code to cause the network entity to:
output, via the control signaling, the second control signaling, or both, a binary mask associated with the virtual cell, wherein the set of serving cells associated with the virtual cell are determined based at least in part on the set of physical cell identifiers and the binary mask.

29. A method for wireless communications at a user equipment (UE), comprising:
receiving control signaling that indicates a virtual cell comprising a set of serving cells that are grouped together to facilitate wireless communication, a plurality of candidate serving cells for selecting the set of serving cells of the virtual cell, or both;
monitoring for second control signaling from a first serving cell of the set of serving cells of the virtual cell based at least in part on the control signaling, the second control signaling indicating a set of physical cell identifiers associated with the set of serving cells of the virtual cell, a set of frequency resources associated with set of serving cells of the virtual cell, or both;
performing a cell selection procedure to access the set of serving cells of the virtual cell based at least in part on the second control signaling; and
communicating with the set of serving cells of the virtual cell in accordance with successful performance of the cell selection procedure.

30. A method for wireless communications at a network entity, comprising:
outputting control signaling that indicates a virtual cell comprising a set of serving cells that are grouped together to facilitate wireless communication, a plurality of candidate serving cells for selecting the set of serving cells of the virtual cell, or both;
outputting second control signaling via a first serving cell of the set of serving cells of the virtual cell based at least in part on the control signaling, the second control signaling indicating a set of physical cell identifiers associated with the set of serving cells of the virtual cell, a set of frequency resources associated with set of serving cells of the virtual cell, or both;
performing a cell selection procedure with a user equipment (UE) to enable the UE to access the set of serving cells of the virtual cell based at least in part on the second control signaling; and
communicating with the UE via the set of serving cells of the virtual cell in accordance with successful performance of the cell selection procedure.
